(19) United States
(12) Patent Application Publication
(10) Pub. No.: US 2004/0073487 A1
(43) Pub. Date: Apr. 15, 2004

(54) Retail systems and methods employing a product shelf interface to provide purchase incentives

(76) Inventors: Ken R. Powell, Athens, GA (US); Thomas M. Hintz, Perris, CA (US); Eleanor B. Hartley, Crawford, GA (US)

Correspondence Address: Law Office of Jerome D. Jackson, Suite 100, 211 N. Union Street, Alexandaria, VA, 22314, US

(21) Appl. No.: 10/601,901

(22) Filed: Jun. 24, 2003

Related U.S. Application Data
(63) Continuation of application No. 10/300,917, filed on Nov. 21, 2002, now abandoned.
Application No. 10/300,917 is a continuation-in-part of application No. 09/317,439, filed on May 24, 1999, now abandoned.
(60) Provisional application No. 60/333,152, filed on Nov. 27, 2001.

(51) Int. Cl. G06F 17/60

(52) U.S. Cl. 705/14; 705/1

(57) ABSTRACT

Disclosed are retail systems and methods employing a product shelf interface to provide purchase incentives.

This Application is a Continuation of copending application Ser. No. 10/300,917, of Ken R. POWELL, Thomas M. HINTZ, and Eleanor B. MAXWELL, filed Nov. 21, 2002 for RETAIL SYSTEMS AND METHODS EMPLOYING A PRODUCT SHELF DISPLAY TO PROVIDE PURCHASE INCENTIVES, the contents of which are hereby incorporated by reference; which is a Continuation-in-Part of application Ser. No. 09/317,439, of Ken R. POWELL, Thomas M. HINTZ, and Eleanor B. MAXWELL, filed May 24, 1999 for RETAIL SYSTEMS AND METHODS EMPLOYING A PRODUCT SHELF DISPLAY TO PROVIDE PURCHASE INCENTIVES, the contents of which are hereby incorporated by reference.

application Ser. No. 10/300,917 claims the benefit of U.S. Application Serial No. 60/333,152 of Ken R. POWELL, Thomas M. HINTZ, AND Eleanor B. MAXWELL filed Nov. 27, 2001 for RETAIL SYSTEMS AND METHODS EMPLOYING A PRODUCT SHELF DISPLAY TO PROVIDE PURCHASE INCENTIVES, the contents of which are herein incorporated by reference.

### BACKGROUND OF THE INVENTION

1. Field of the Invention

This invention relates generally to a commercial system and, more particularly, to retail systems and methods to provide purchase incentives.

2. Description of Related Art

Product promotions employing price discounts are a popular means to stimulate sales of products such as grocery store items.

### SUMMARY OF THE INVENTION

It is an object of the present invention to provide retail systems and methods to provide purchase incentives.

To achieve this and other objects of the present invention, there is a method for a system including a first store with a shelf. The method comprises the step, performed in the first store, of detecting a first product purchased by a customer. The method further includes displaying an amount for a second product, from the shelf, depending on the detecting step.

According to another aspect of the present invention, there is a system for operating with a first store having a shelf. The system comprises a detector that detects a first product purchased by a customer, to generate a first signal; and a display on the shelf, the display acting to display an amount for a second product, responsive to the first signal.

According to yet another aspect of the present invention, there is a system for operating with a first store with a shelf a first store with a shelf. The system comprises means for detecting a first product purchased by a customer; and means for displaying an amount for a second product, from the shelf, depending on the detecting step.

### BRIEF DESCRIPTION OF THE DRAWINGS

FIG. 1 is a diagram of a system in accordance with the first preferred embodiment of the present invention.

FIG. 2 is a plan view of the retail store in accordance with a first preferred embodiment.

FIGS. 3A and 3B are another type of view of a part of the first preferred retail store.

FIGS. 4A and 4B are the other type of view of another part of the first preferred retail store.

FIG. 5 is a flow chart of a process performed in the first preferred system.

FIGS. 6A and 6B are a flow chart showing part of the process of FIG. 5 in more detail.

FIGS. 7A, 7B, and 7C are enlarged views of some products shown in FIGS. 4A and 4B.

FIG. 8 is a diagram of a shelf unit shown in FIG. 3A after processing a first customer card.

FIGS. 9A and 9B are a flow chart of a process performed by the shelf units shown in FIGS. 3A and 3B.

FIG. 10 is a block diagram of the first customer card.

FIG. 11 is a diagram of some records on the first customer card.

FIG. 12 is a block diagram of a check-out station shown in FIG. 4A.

FIG. 13 is a diagram of a table for controlling awards of discounts to customers.

FIG. 14 is a flow chart showing part of the process of FIG. 6A in more detail.

FIG. 15 is a block diagram of the shelf unit shown in FIG. 8.

FIG. 16 is a more detailed diagram of some memory contents of the shelf unit.

FIG. 17 is a diagram of some records on a second customer card.

FIG. 18 is a diagram of some records on a third customer card.

FIG. 19 is a diagram of the shelf unit shown in FIG. 3A after processing the second customer card.

FIG. 20 is a diagram of a table for controlling coupon processing during store checkout transactions.

FIGS. 21A and 21B are a schematic diagram of a retail system in accordance with the second preferred embodiment of the present invention.

FIG. 22A is a plan view of one of the customer cards in the second preferred system.

FIG. 22B is a side view of the card shown in FIG. 22A.

FIG. 22C is an enlarged, partial view of the card shown in FIG. 22A.

FIG. 23 is a block diagram of the customer card.

FIG. 24 is a diagram of one of the product stations for transferring an electronic coupon to the card.

FIG. 25 is a block diagram of the product station shown in FIG. 24.

FIG. 26 is a block diagram of the check-out station shown in FIG. 21.

FIG. 27 is a flow chart of a processing performed by one of the product stations.

FIGS. 28A and 28B are diagrams of some memory contents of the customer card at different points in time.

FIGS. 29A and 29B are diagrams of some memory contents of one of the product stations at different points in time.

FIG. 30 is a flow chart of a processing performed by the check-out station.

FIG. 31 is a flow chart of a processing performed by one of the customer cards.

FIG. 32 is a block diagram of a system including a clearing house and multiple check-out stations.

FIG. 33 is a block diagram of a check-out counter in accordance with an alternative embodiment of the present invention.

FIG. 34 is a flow chart of a processing performed by the check-out station shown in FIG. 31.

FIG. 35 is a block diagram of a customer card according to an alternative embodiment of the present invention.

FIG. 36 is a flow chart of a processing performed by the customer card shown in FIG. 33.

FIG. 37 is a block diagram of a programming card in the second preferred system.

FIG. 38 is a flow chart of a processing performed by the programming card.

FIG. 39A is a plan view of one of the programming card in the second preferred system.

FIG. 39B is a side view of the card shown in FIG. 39A.

FIG. 39C is an enlarged, partial view of the card shown in FIG. 39A.

The accompanying drawings which are incorporated in and which constitute a part of this specification, illustrate embodiments of the invention and, together with the description, explain the principles of the invention, and additional advantages thereof. Throughout the drawings, corresponding elements are labeled with corresponding reference numbers.

### DESCRIPTION OF THE PREFERRED EMBODIMENTS

First Preferred Embodiment

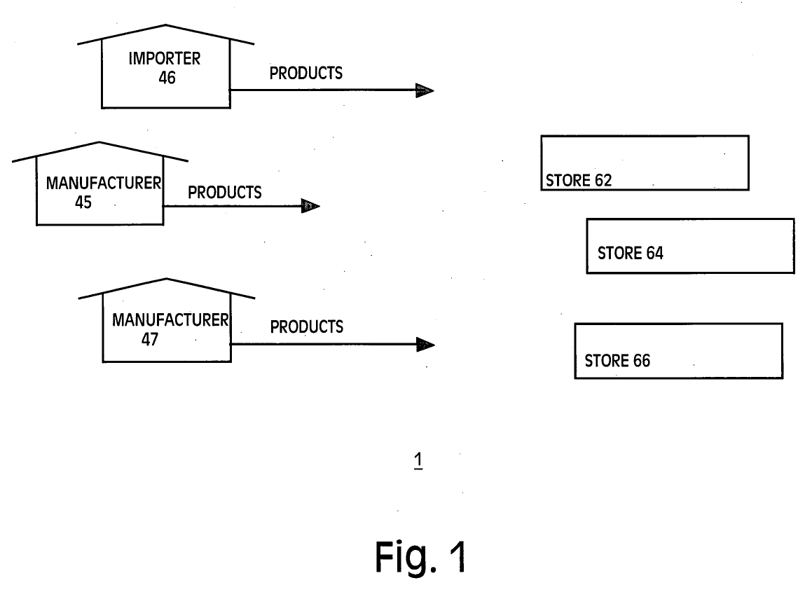

FIG. 1 shows commercial system 1 in accordance with a first preferred embodiment of the present invention. System 1 includes grocery stores 62, 64, 66; manufacturers 45 and 47; and importer 46. Manufacturer 45 is the Delta Corporation. The product line of the Delta Company includes Delta Brand Clothes Detergent. Importer 46 is the Alpha Imports Corporation, which obtains products manufactured by other corporations and distributes the products under the name of Alpha Imports. Products distributed by Alpha Imports include Old World Pasta. Manufacturer 47 is the Beta Corporation. The product line of the Beta Corporation includes Lighthouse Light bulbs, and Beta Brand Clothes Detergent.

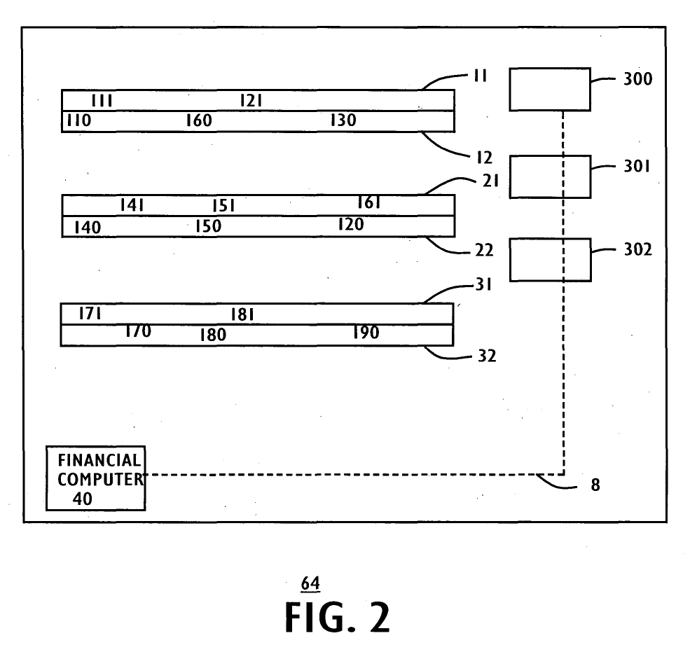

FIG. 2 shows a plan view of store 64. Shelves 11, 12, 21, 22, 31, and 32 include product areas 111, 121, 110, 120, 130, 141, 151, 161, 140, 150, 160, 171, 181, 170, 180, and 190. Each product area includes a plurality of units of a respective product. For example, product area 110 has Delta brand Clothes Detergent, product area 120 has Old World brand pasta, and product area 130 has Lighthouse brand light bulbs.

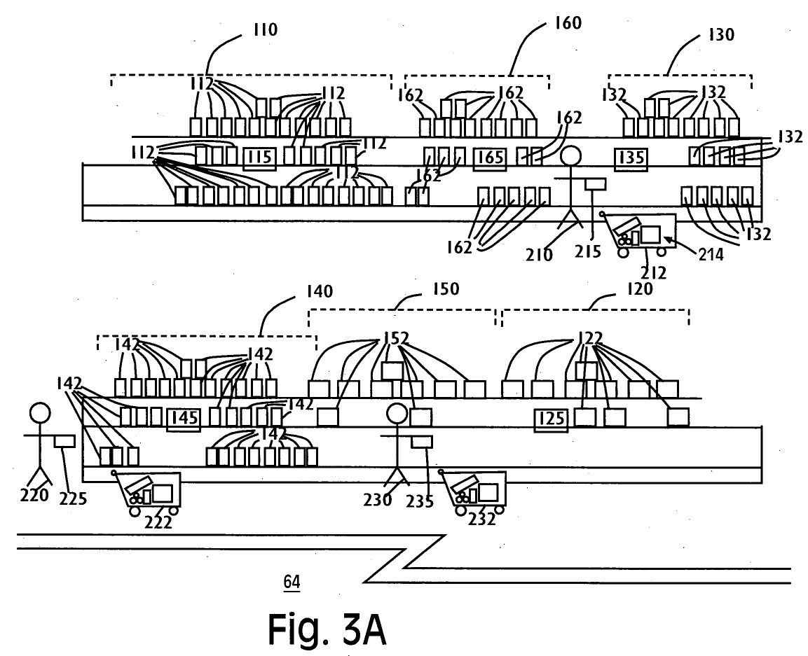

FIGS. 3A, and 3B are each a partial view of 64. Customers 210, 220, 230, 240, 270, 280, 290, 390, 470, 480, and 490 shop in store 64.

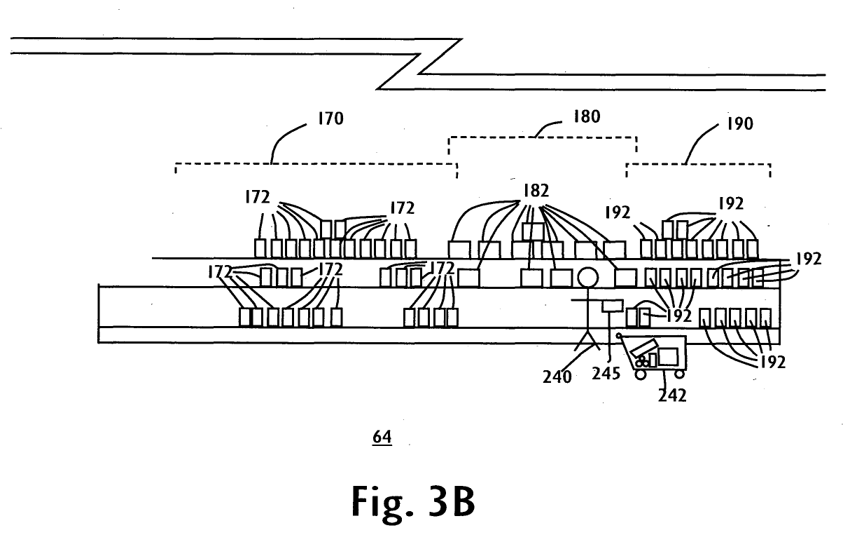

As shown in FIGS. 4A and 4B, financial computer 40 sends product pricing data to checkout stations 300, 301, and 302 via cable 8. Each of checkout stations 300, 301, and 302 includes a UPC bar code reader that detects an optical (electromagnetic) signal reflected from a UPC bar code symbol. Checkout station 300 includes reader/writer 315 having a card interface slot 314, checkout station 301 includes reader/writer 315 having a card interface slot 314, and checkout station 302 includes reader/writer 315 having a card interface slot 314.

Processes performed by the circuitry of system 1 are described below. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

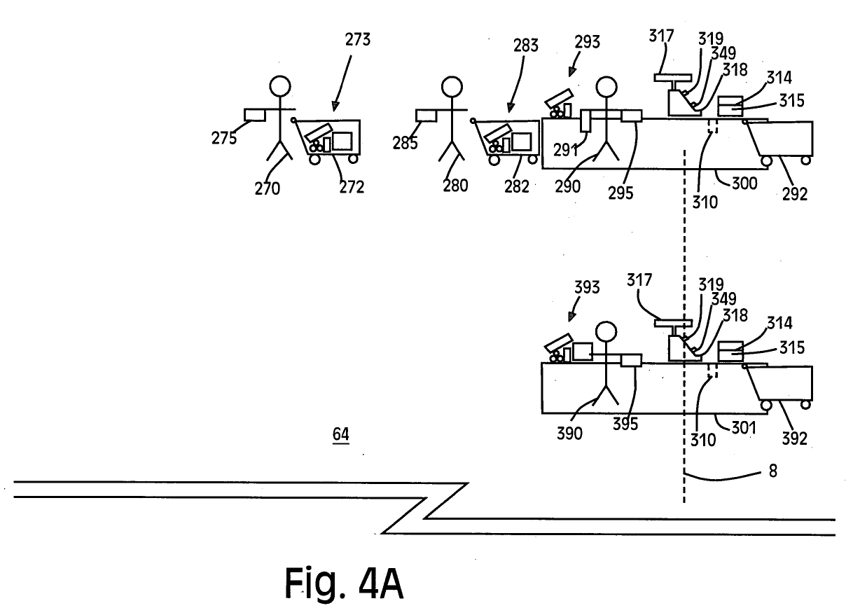

FIG. 5 shows a processing performed in system 1. One of stores 62, 64, or 66 sells products and writes discount data onto a customer card (step 5). One of stores 62, 64, or 66 selectively displays a message from the product shelf depending on discount on the card (step 10). The store that performs step 5 is not necessarily the same store that performs step 10.

Checkout Processing in the First Preferred Embodiment—Generation of Points

Upon completion of shopping, each customer brings selected products from the shelves to checkout stations 300, 301, or 302. Customers check out of store 64 by presenting a customer card, allowing the store clerk to insert the presented card into a smart card reader/writer 315. For example, a customer such as customer 290 completes the purchase of her selected products 293 by transferring products 293 from her cart 292 to station 300, and by presenting card 295 for insertion into card interface slot 314; customer 270 completes the purchase of her selected products 273 by transferring products 273 from her cart 272 to station 300, and by presenting card 275; customer 280 completes the purchase of her selected products 283 by transferring products 283 from her cart 282 to station 300, and by presenting card 285; customer 390 completes the purchase of her selected products 393 by transferring products 393 from her cart 392 to station 301, and by presenting card 395; customer 490 completes the purchase of his selected products 493 by transferring products 493 from his cart 492 to station 302, and by presenting card 495; customer 480 completes the purchase of his selected products 483 by transferring products 483 from his cart 482 to station 302, and by presenting card 485; customer 470 completes the purchase of his selected products 473 by transferring products 473 from his cart 472 to station 302, and by presenting card 475. Customer 210 (FIG. 3A) completes the purchase of her selected products 214 by transferring products 214 from her cart 212 to station 300, and by presenting card 215 for insertion into card interface slot 314.

To perform step 5 of FIG. 5, a checkout clerk (not shown) scans each selected product past bar code reader 310, or enters the product selection information manually via keyboard 318. Station 300 thus detects products selected by the customer. After station 300 determines a basic price for a product by processing a message received from computer 40, station 300 displays the description of the product and product price on display 317. Station 300 may conditionally write company points onto the customer's card, or may conditionally write a coupon for a specific product onto the customer's card. Station 300 scans and processes each product 293 in a similar manner. Checkout station 300 determines a total amount due and prints the total amount due on display 317 and on the customer's paper receipt.

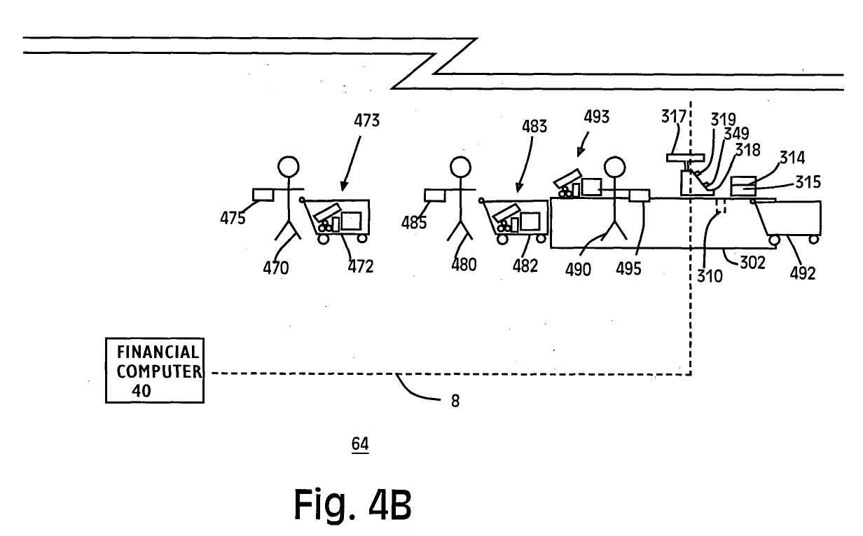

FIGS. 6A and 6B show the processing of step 5 of FIG. 5 in more detail. Station 300 detects a product selected by a customer, by receiving a UPC product code from bar code reader 310 or keyboard 318. (step 5). Station 300 determines a price for the product, by processing a message from financial computer 40. (step 10). In step 20, station 300 may increment the points field of a memory area by a certain fraction of the price of the product, or may write a coupon into the memory area.

If the checkout transaction for the current customer is complete (step 25), station 300 writes any card memory modifications to the customer card. (step 30). Station 300 determines a total amount due depending on the sum of the product prices from the various executions of step 10, minus any product discounts. Station 300 displays this total amount due on display 317 and the customer's receipt tape. (Step 35).

Store Layout Discount Processing, and Product Selection in the First Preferred Embodiment

As shown in FIGS. 3A and 3B some of the product areas have a respective shelf unit for writing an electronic coupon onto a customer card. Product Area 110 has Shelf unit 115. Product Area 120 has Shelf unit 125. Product Area 130 has Shelf unit 135.

Product Area 110 has bottles of detergent 112 grouped together on multiple shelves. Bottles of detergent 112 are contiguously grouped, meaning that no other product is between any two bottles of detergent 112. No other product is between shelf unit 115 and bottles of detergent 112. Shelf unit 115 is on a shelf under some of the bottles 112 and over some of the bottles 112. In other words, Shelf unit 115 is adjacent to bottles 112 and supported by a shelf that is in vertical alignment with some of the bottles 112.

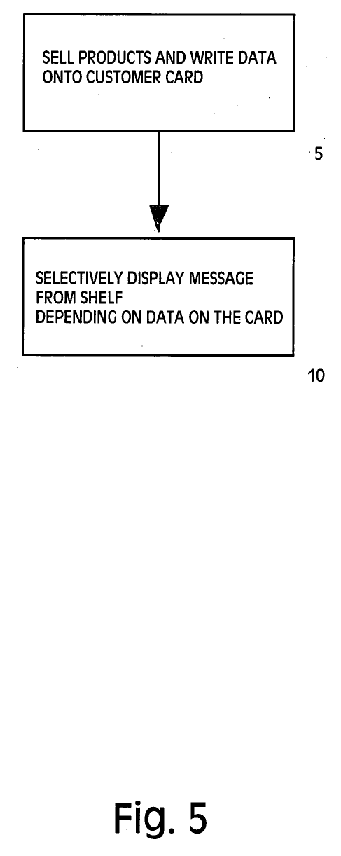

FIG. 7A shows an enlarged view of some of the bottles of detergent 112. Each bottle of detergent has a common Universal Product Code (UPC) symbol 114. Symbol 114 encodes a 12-digit UPC number that is part of a product identification system documented by the Uniform Code Council, Inc., Dayton, Ohio. The first digit is a number system character, which in this case is 0. The next five digits are a company number, which is sometimes called a manufacturer ID. The next 5 digits are an item number. The last digit is a check digit.

Each UPC symbol 114 is a group of parallel lines that encodes a number (0 17075 00003 3) that uniquely identifies Delta Clothes Detergent, 17075 being the UPC company number of the Delta Corporation. In other words, symbol 114 is different from UPC symbols of units of other products. Each bottle of detergent 112 also has a common character label 113 that verbally describes the product. Character label 113 is “DELTA DETERGENT.” Label 113 is different from labels of units of other products.

Product Area 120 has boxes of Old World brand pasta 122 contiguously grouped together on multiple shelves. FIG. 7B shows an enlarged view of some of the boxes of pasta 122. Each box of pasta 122 has a common UPC symbol 124, which is a group of parallel lines that encodes a number (0 17031 00005 3) that uniquely identifies Old World pasta, 17031 being the UPC company number of the Alpha Imports Corporation. In other words, symbol 124 is different from UPC symbols of units of other products. Each box of pasta 122 also has a common character label 123 that verbally describes the product. Character label 123 is “OLD WORLD PASTA.” Label 123 is different from labels of units of other products.

Product Area 130 has boxes of Lighthouse brand light bulbs 132 grouped together on multiple shelves. FIG. 7C shows an enlarged view of some of the boxes of light bulbs 132. Each box of light bulbs 132 has a common UPC symbol 134, which is a group of parallel lines that encode a number (0 17054 1017 6) that uniquely identifies Lighthouse light bulbs, 17054 being the UPC company number of the Beta Corporation. In other words, symbol 134 is different from UPC symbols of other products. Each box 132 also has a common character label 133 that verbally describes the product. Character label 133 is “LIGHTHOUSE LIGHT BULBS.” Label 133 is different from labels of other products.

Product Area 160 has bottles of Beta brand Clothes Detergent 162 grouped together on multiple shelves. FIG. 7D shows an enlarged view of some of the bottles of detergent 162. Each bottle of detergent 162 has a common UPC symbol 164, which is a group of parallel lines that encode a number (0 17054 0635 2) that uniquely identifies Beta brand Clothes Detergent, 17054 being the UPC company number of the Beta Corporation. In other words, symbol 164 is different from UPC symbols of other products. Each bottle 162 also has a common character label 163 that verbally describes the product. Character label 163 is “BETA DETERGENT.” Label 163 is different from labels of other products.

Similarly, other product areas have a set of respective products contiguously grouped together. Respective units of a certain product have a common UPC symbol, different from UPC symbols on units of other products, that uniquely identifies the certain product. Respective units of a certain product have a common label, different from labels on units of other products, that uniquely identifies the certain product. Referring to FIGS. 2, 3A, and 3B product area 140 has bottles of ABC brand ketchup 142 contiguously grouped together, and shelf unit 145. Product area 150 has boxes of Fido brand dog food 152 contiguously grouped together, and no shelf unit. Product area 170 has cartons of Clover brand milk 172 contiguously grouped together, and no shelf unit. Product area 180 has packages of Chicago brand bacon 182, and no shelf unit. Product area of 190 has packages of Clover brand butter 192 contiguously grouped together, and no shelf unit.

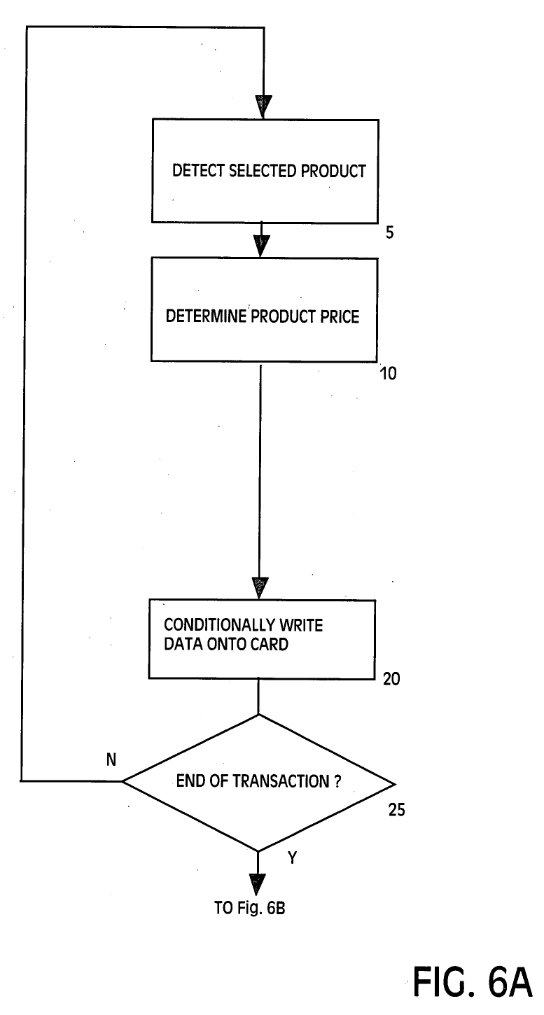

FIG. 8 shows shelf unit 115, including liquid crystal display (LCD) 360, and interface slot 352. Shelf unit 115 has no external wires connecting shelf unit 115 to another device. When customer card 215, for example is in interface slot 352, conductive contact 354 inside interface slot 352 touches a contact on the customer card. Interface slot 352 has other contacts (not shown) for touching the other card contacts.

While shopping in store 64, each of customers 210, 220, 230, 240, 270, 280, and 290 carries his or her respective customer card. A card may store one or more company entries for recording points for a certain company. Each data entry includes a company field and a points field for storing accumulated points earned by purchasing products associated with the company.

To receive an electronic coupon in the store, a customer may insert her respective card into the shelf unit adjacent to the product the customer wishes to purchase, and the shelf unit then selectively writes an electronic coupon onto the card depending on any point entries on the card. In other words, the shelf unit selectively writes an electronic coupon into a memory on the card, in response to a person presenting the card at the shelf unit, and depending on points stored on the card. Shelf unit 115 may store a plurality of different types of coupons for a common product, each coupon having a different discount amount. Shelf unit 115 may select one of the coupon types depending on whether the customer card stores a sufficient quantity of points for the coupon.

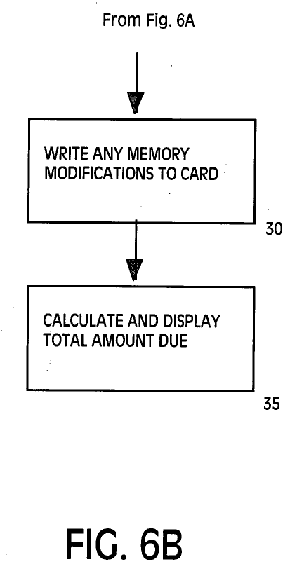

FIGS. 9A and 9B show a processing performed by Shelf Unit 115. When a customer presents a card to shelf unit 115, shelf unit 115 reads a list of coupons from the card. If the list on the card already contains a coupon of the type dispensable by shelf unit 115 (step 1), shelf unit 115 displays a message for the coupon (step 2) and does not attempt to dispense any more coupons to the card. If the card does not contain a coupon of the type dispensable by shelf unit 115, shelf unit 115 examines a first coupon type dispensable by shelf unit 115. (Step 5). Shelf unit 115 examines data from the customer card to determine whether the customer meets the criteria for receiving the currently examined coupon. (Step 10). If the customer does not meet the requirements for the current coupon, shelf unit 115 determines whether there are coupons remaining (step 15). If there are coupons remaining, shelf unit 115 examines the remaining coupon types to determine whether the customer meets the requirements for receiving one of the remaining coupon types. (Steps 20, 10, etc.). If the customer does meet the requirements for receiving one of the coupon types dismissible by shelf unit 115, shelf unit 115 sends the coupon to the customer card (Step 25). And displays a message to the customer indicating the discount quantity of the coupon received. (Step 30).

If the customer is not eligible to receive any of the coupons dispensable by shelf unit 115, shelf unit 115 displays a message to so inform the customer. (Step 22). If the customer has insufficient points to qualify for a coupon in this shelf unit, step 22 may also display how many additional points are required, by displaying the difference between the relevant points on the card and the lowest threshold in table 251.

The customer also removes the product from the shelf and places the removed product into her cart.

Checkout Processing in the First Preferred Embodiment—Redemption of Coupons

After receiving an electronic coupon from a shelf unit and completion of shopping, a customer may bring selected products from the shelves to checkout station 300, 301, or 302, as described above. A customer may redeem the electronic coupons received from a shelf unit by presenting her customer card, allowing the store clerk to insert the presented card into smart card reader/writer 315. Station 300, 301, or 302 then reads the coupon offers from the card. Station 300, for example, performs electronic coupon redemption, by processing the selected products in the context of coupon information from the customer's card to determine discount eligibility. After station 300 determines a basic price for each product by processing a message received from computer 40. Station 300 processes electronic coupons from a customer card, to deduct any discounts from the basic price to calculate and display a total amount due. At the conclusion of the checkout transaction, station 300 notifies the clerk to remove the customer's card from slot 314 and return it to the customer.

More Detailed Description of the First Preferred Embodiment

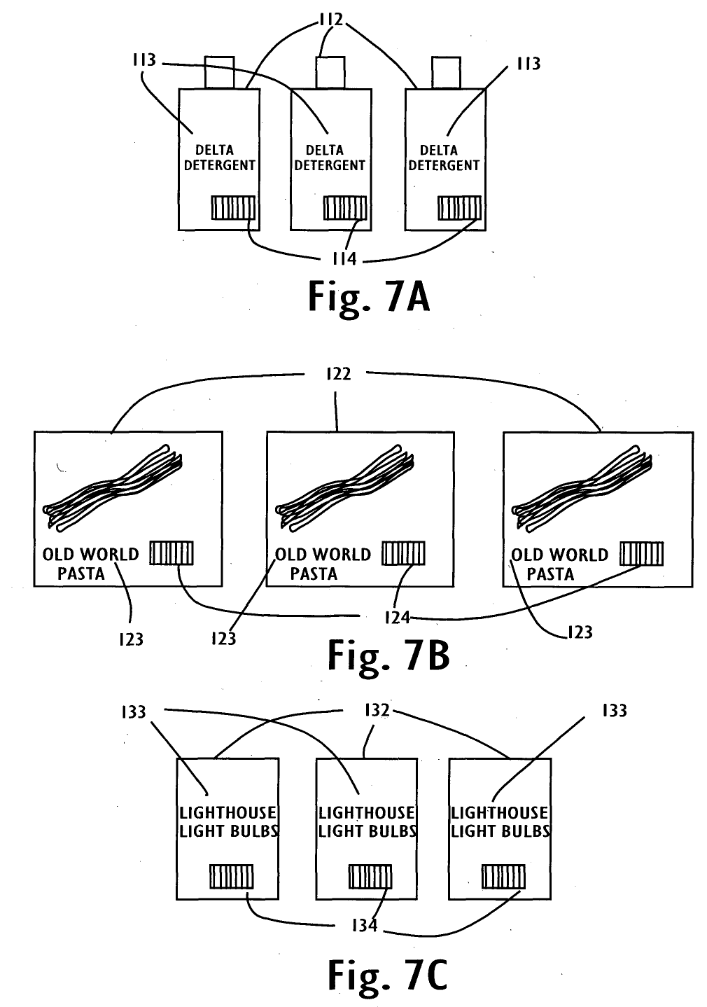

FIG. 10 is a block diagram of customer card 215, including CPU 450, and memory 460. Memory 460 includes three addressable segments: nonvolatile read only memory (ROM) 461; nonvolatile, electrically erasable memory (EEPROM) 462; and memory 463 for temporary storage. Station interface 425 includes a serial to parallel converter for transferring data signals between contacts, on the exterior of card 215, and CPU 450 over parallel bus 452. ROM 461 stores a program 465 executed by CPU 450. EEPROM 462 stores customer card identification data 467. Customer card identification data 467 is a 6 byte field that uniquely identifies the card. For example, identification data 467 in customer card 235 uniquely identifies the card held by customer 230.

EEPROM 462 also stores company points table 404. When purchasing a product at a checkout station, the checkout station may increment the value of a points field in company points table 404.

EEPROM 462 also stores coupon table 465 (product pricing data) received from one or more shelf units. When a customer inserts a customer card into a shelf unit, card CPU 450 may receive a coupon code for the product from the shelf unit and add the code to table 465.

Each of customer cards 235, 245, 275, 285, 295, 395, 475, 485, and 495 have the same hardware structure as card 215.

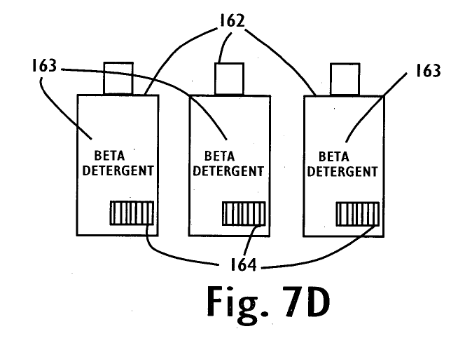

FIG. 11 shows a simplified, abstract, view of company points table 404 and coupon table 435. Company points table 404 is a data structure within other data structures in EEPROM 462. Each row in table 404 represents an entry in table 404, and each of the two columns represents a field within each entry. The entry on the left is a company identification (ID) field. The entry on the right is a points field that reflects a total value of product, for the company identified by the left field, purchased by customer 215.

Coupon table 435 is a data structure within other data structures in EEPROM 462 of customer card 215. Each row in table 435 represents an entry in table 435. Each entry includes a 4 hexadecimal digit coupon number. Table 435 has three entries, reflecting the fact that customer 210 has received three electronic coupons from coupon dispensing devices. The entry having the coupon number 1317 corresponds to a coupon for purchase of a box of Old World Pasta 122. The entry having the coupon number 0054 corresponds to a coupon for purchase of a box of Lighthouse Light Bulbs 134. The entry having the number 3657 corresponds to a coupon for purchase of detergent bottles 112.

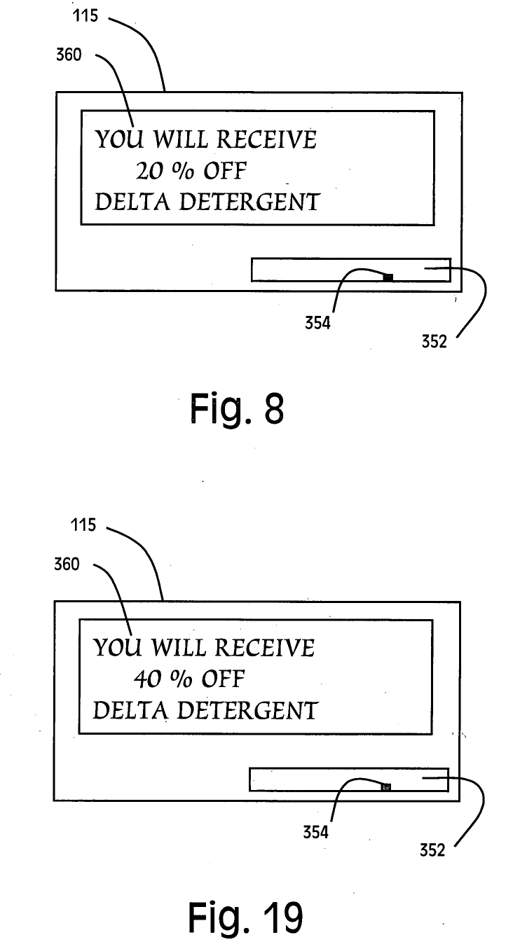

FIG. 12 is a block diagram of checkout station 300. Programmable hardware 339 executes software instructions 340 in memory hardware 303. Cash register keyboard 318 allows manual entry of alpha-numeric data. Bar code reader 310 generates a bar code signal, and sends the bar code signal to hardware 339. Poll display 317 displays product data in response to signals from hardware 339. Hardware 339 and software instructions 340 act to receive electronic coupons from a customer card, via reader/writer 315. Memory hardware 303 stores issuance control table 345, which enables hardware 339 to determine whether to issue a coupon, or other discount data, to a customer. Memory hardware 303 stores redemption control table 347, which enables hardware 339 to determine if a product has a corresponding electronic coupon offer.

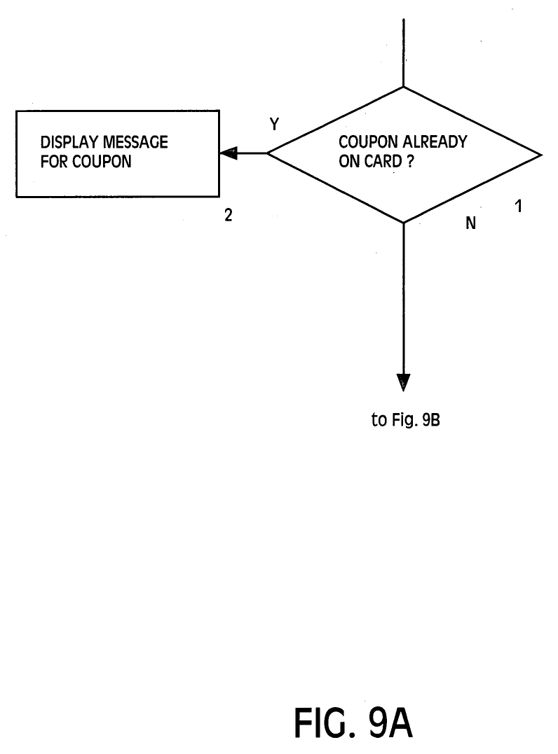

FIG. 13 is a simplified diagram of redemption control table 345 stored in card interface station 300. Each row in FIG. 13 represents an entry in table 345, and each of the 3 columns shown represents an entry field. An issuance control table may include additional entries, and additional fields for recording other types of information.

The first field in FIG. 13 is a company ID in the UPC system. The second field is either a product number in the UPC system, or 0. In entries where the second field is non-zero, the third field is a coupon ID stored as 4 hexadecimal digits.

When station 300 detects insertion of a customer card into reader/writer 315, station 300 reads company points table 404 and coupon table 435 into temporary versions of tables 303 and 435 in memory hardware 303.

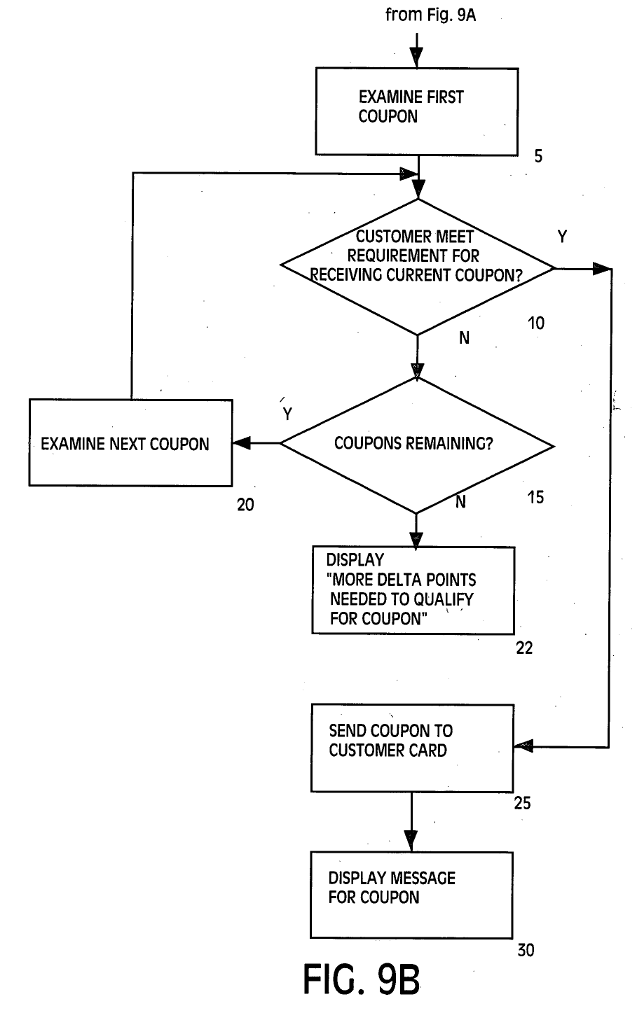

FIG. 14 shows a processing of step 20 of FIG. 6A in more detail. After detecting a product selected by the customer, hardware 339 searches the company identification field of table 345 for a company number matching company number of the UPC product code. (step 5). If hardware 339 finds such a matching entry in table 345, hardware 339 determines whether the product number field is equal to 0 (step 10), and if the product number field is equal to 0 hardware 339 searches the company identification field of table 404 for a matching entry, and increments the points field in table 404 by a predetermined fraction of the product price, if a matching entry in table 404 is found. Otherwise, in step 30 hardware 339 creates an entry for the company and initializes the points field of the entry to the predetermined fraction of the product price. (step 30).

If the points field of the current entry in table 345 is not equal to 0, hardware 339 determines whether the product field of the current entry in table 345 matches the product field of the purchase product (step 15), and writes the coupon field of table 345 into table 435 of the customer card if there is such a match of the product number field. (step 25).

The processing of steps 20 and 40 acts to process any multiple matching entries for the company ID field in table 345, in cases where such multiple entries exist in table 345. Thus, multiple discount programs may be in effect concurrently. For example, the Delta corporation may reward customer loyalty with a graduated point-based loyalty program, and may also encourage brand switching with a program effected by an entry in table 345 having company ID and product number fields for a competing company and a corresponding coupon ID field for a product of a Delta Corporation.

At the conclusion of the checkout transaction, hardware 339 writes the temporary versions of tables 404 and 435, stored in memory hardware 303, to the customer card. (See FIG. 6B step 30).

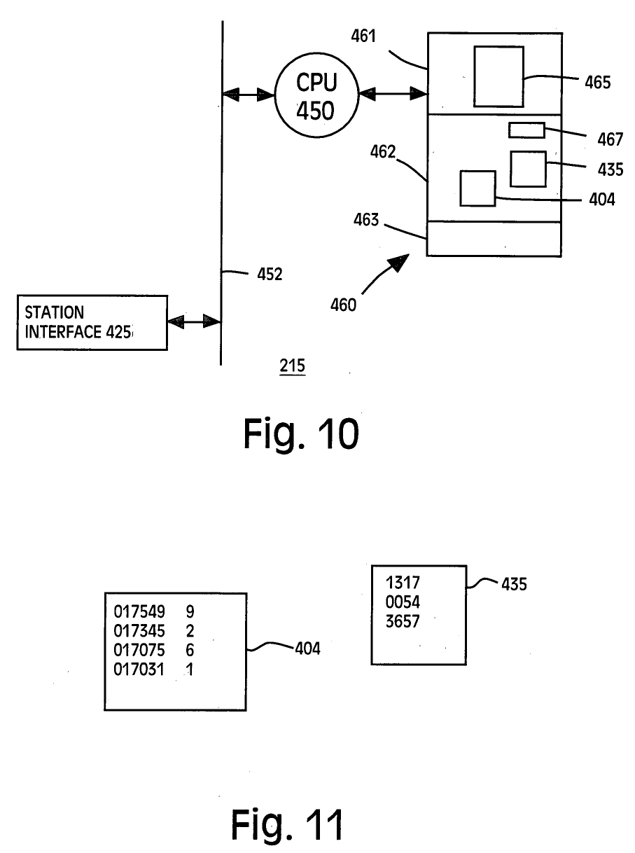

FIG. 15 shows a block diagram of shelf unit 115, including CPU 247, nonvolatile memory 248, card contact interface 252, and battery 249. Memory 248 stores program 250, executed by CPU 247, and offer table 251. Memory 248 may include sections of ROM and EEPROM.

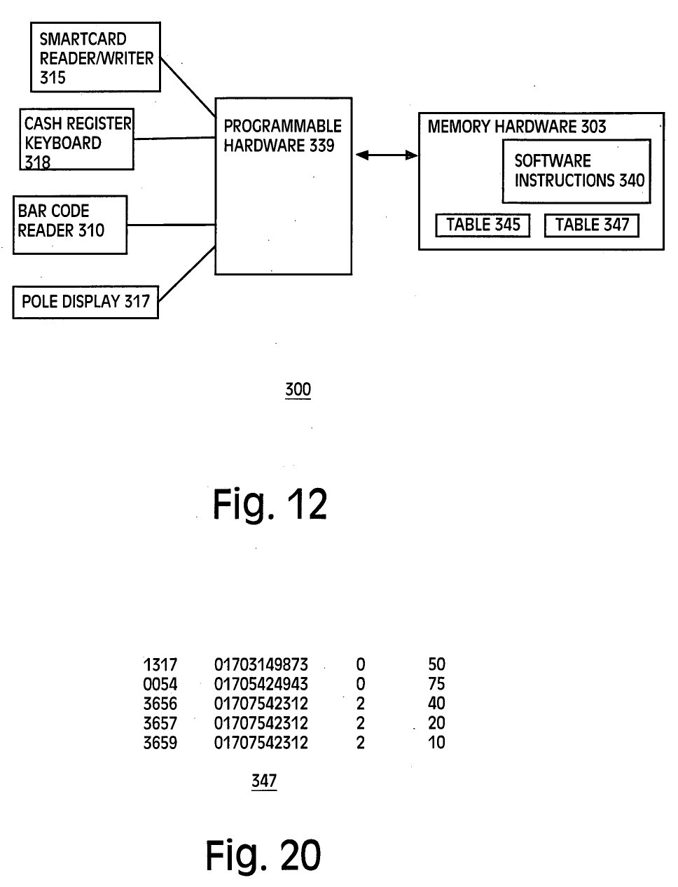

FIG. 16 shows offer table 251. Each row in table 251 represents an entry in table 251. Each of the four columns represents a field in each entry. The first column represents a coupon ID field. The second column represents a company ID field. The third column represents a point threshold field for the coupon. The fourth column represents a message field to be displayed if a customer's card contains the coupon.

When a person inserts a card into slot 352 of shelf unit 115, a switch (not shown) in slot. 352 alerts CPU 247 that a card has been inserted into the slot. Subsequently, CPU 247 causes contact interface electronics 252 to reset the card. CPU 252 then receives a header record, coupon table 435, and company points table 404 from the card. CPU 247 examines coupon table 435 to determine if the card already stores a coupon dispensable by unit 115. (See FIG. 9A, step 1). If the card contains such a coupon, CPU 247 uses table 251 to display a message showing the discount amount for the coupon. (See FIG. 9A, step 2). If coupon table 435 does not have such an entry CPU 247 examines the entry in table 251 having the highest point threshold field, which in this case would be the entry having the point threshold field of 8. (See FIG. 9B step 5). CPU 247 decides that the customer is eligible to receive the coupon of the current entry in table 251 and if the customer ID field of the current entry of table 251 matches one of the company ID fields of table 404 and the points field of any matching entry and table 404 is greater than or equal to the point threshold field and the current entry in table 251. (See FIG. 9B step 10).

If the customer card satisfies the criteria of an entry in table 251, CPU 247 appends the coupon ID field of the matching entry to coupon table 435 on the customer card. CPU 247 also decrements the points field of the matching entry of points table 404 and writes the updated table 404 to the customer card. (See FIG. 9B step 25). CPU 247 then sends the message field of the matching entry in table 251 to LCD display 360. (See FIG. 9B step 30).

Thus, referring to FIGS. 8, 9A, 9B, 11, and 16, when customer 210 presents card 215 to shelf unit 115, unit 115 effects the second entry in table 251 by displaying “20% OFF” on LCD display 360 and writing 3657 into table 435 of card 215. More specifically, the third entry of table 404 of card 215 has a company ID field of 017075, which matches the company ID of the second entry in table 251; and the third entry of table 404 has a points field of 6, which is greater than the points threshold of the second entry in table 251 (6).

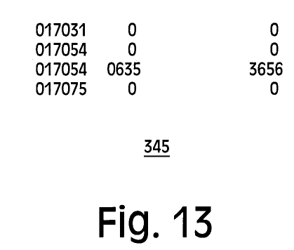

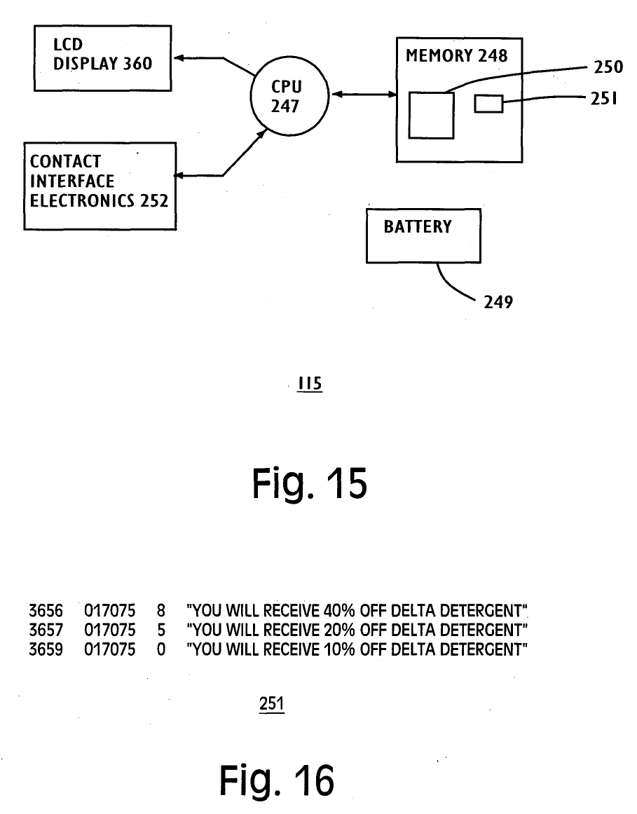

FIG. 17 shows a simplified, abstract, view of company points table 404′ and coupon table 435′ stored on customer card 235. FIG. 19 shows shelf unit 115 after customer 230 presents card 235 to shelf unit 115. In other words, referring to FIGS. 19, 9, 17, and 16, when customer 230 presents card 235 to shelf unit 115, unit 115 effects the first entry in table 251 by displaying “40% OFF” on LCD display 360 and writing 3656 into table 435′ of card 235. More specifically, the second entry of table 404′ of card 235 has a company ID field of 017075, which matches the company ID of the first entry in table 251; and the second entry of table 404′ has a points field of 8, which is equal to the points threshold of the first entry in table 251 (8).

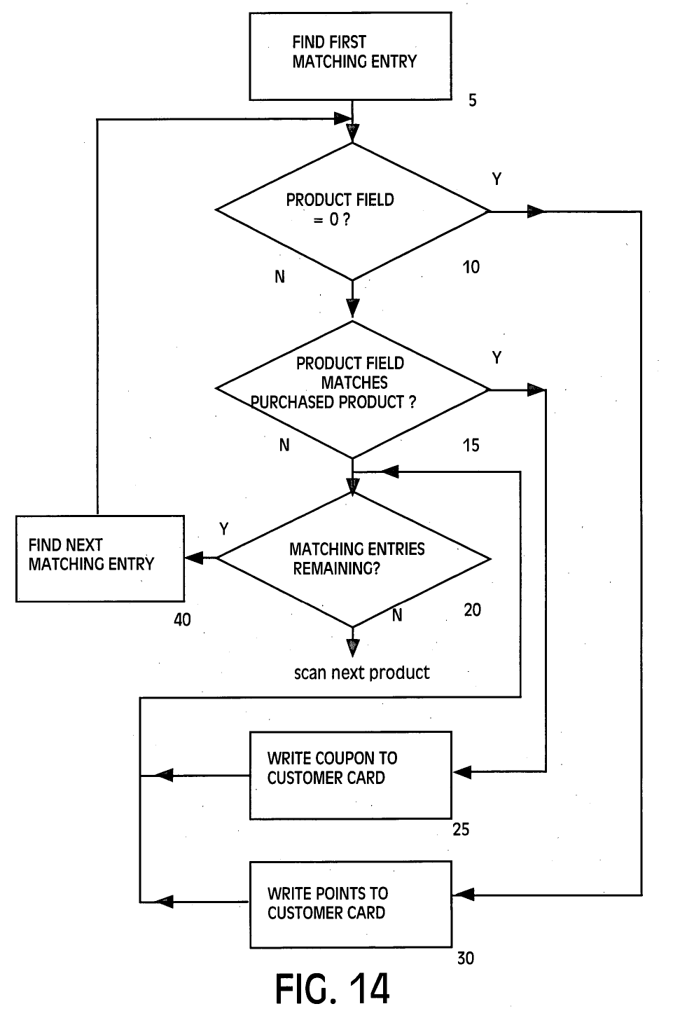

FIG. 18 shows a simplified, abstract, view of company points table 404″ and coupon table 435″ stored on customer card 225. Card 225 already contains coupon 3656 for Delta detergent, since customer 220 purchased Beta detergent on a previous visit to the store and checkout station 300 then wrote coupon 3656 into table 435″. FIG. 19 shows a message displayed by shelf unit 115 after customer 220 presents card 225 to shelf unit 115. In other words, referring to FIGS. 19, 9A, 9B, 17, and 16, when customer 220 presents card 225 to shelf unit 115, unit 115 uses the first entry in table 251 to display “40% OFF” on LCD display 360, as coupon 3656 is already in table 435″ of card 235.

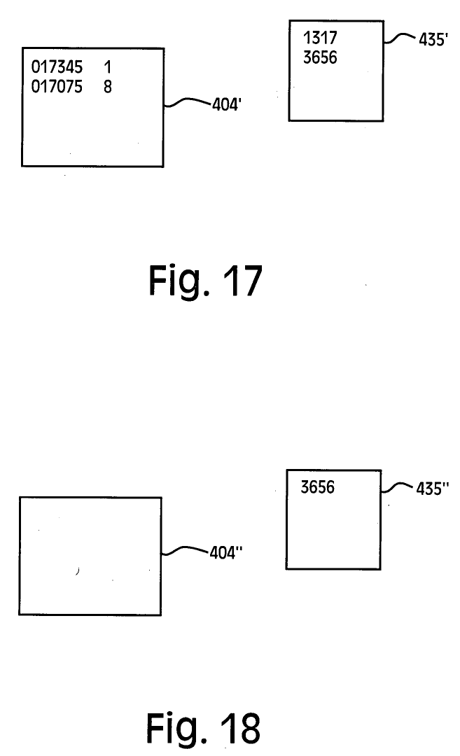

FIG. 20 is a simplified diagram of redemption control table 347 stored in card interface station 300. Each row in FIG. 20 represents an entry in table 347, and each of the 4 columns shown represents an entry field. A redemption control table may include additional entries for additional coupon offers, and additional fields for recording other types of information.

The first field in FIG. 20 is a coupon ID stored as 4 hexadecimal digits. The second field is a UPC product code corresponding to the coupon ID. The second field is stored as binary coded decimal. The third field is a reward type. A reward type of 2 represents a percent off coupon, and a reward type of 0 represents a cents off coupon.

The fourth field in FIG. 20 is the reward quantity.

The first entry shows a reward of 50 cents off because the reward type is 0. The first entry is for a product having a product number of 49873, from a company having a company ID of 017031.

The second entry shows a reward quantity of 75 cents off because the reward type is 0.

The second entry is for a product having a product number of 24943, from a company having a company ID of 017054.

The third entry shows a reward quantity of 40 percent because the reward type field is 2. The third entry is for a product having a product number of 42312, from a company having a company ID of 017075. The company ID 017075 identifies the Delta Company.

The fourth entry shows a reward quantity of 20 percent for the product having the product number 42312 from the company having the ID 017075, which is the Delta Company.

The fifth entry shows a reward quantity of 10 percent for the product having the product number 42312 from the company having the company ID 017075, which is the Delta Company.

Thus, table 347 stores three coupon entries for the same product, each coupon entry having a different reward value.

Checkout stations 301 and 302 each have the same capabilities and hardware as checkout station 300, cash register systems 331 and 332 each have the same capabilities and hardware as cash register station 300, and card interface systems 301 and 302 each have the same capabilities and hardware as card interface station 300.

Processing of step 35 of FIGS. 6A and 6B will now be described in more detail. When hardware 339 receives a valid UPC product code from reader 310 or keyboard 318, hardware 339, hardware 339 adds the product code to a basket list for the current customer. Hardware 339 searches for the received product code in the second field of redemption control table 347, which enables hardware 339 to determine if the product has a corresponding electronic coupon offer. If the product does have an electronic coupon offer, hardware 339 searches coupon table 435 from the customer card to confirm that the customer has the coupon on her card. If the customer has the coupon on her card and qualifier conditions are satisfied for the coupon, hardware 339 adjusts the total amount due by the discount amount of the coupon.

Programmable hardware may include an IBM 4680-4690 Point of Sale (POS) System. Programable hardware 339 may include two CPUs, as disclosed in copending application Ser. No. 09/301,749 of KEN R. POWELL, KEVIN W. HARTLEY, ELEANOR B. MAXWELL, and COREY C. SNOOK for COMPUTER SYSTEM CONFIGURATION AND METHOD FOR A STORE, filed Apr. 29, 1999, the contents of which is herein incorporated by reference. Alternately, hardware 339 may be a single CPU having electronic coupon, or other discount, processing integrated with conventional UPC product scanning and price lookup. Memory hardware 303 may include two independent memories or may be an integrated memory.

Alternatives, to the disclosed coupon ID and matching of a product code in table 347 described above, include a wildcard scheme, or the family-code-based U.P.C. coupon-product(s) correspondence scheme promulgated by the Uniform Code Council Uniform Code Council, Inc., Dayton, Ohio.

Monitoring certain types of electronic coupon dispensers is a subject of copending application Ser. No. 09/301,748 of KEN R. POWELL, KEVIN W. HARTLEY, THOMAS M. HINTZ, ELEANOR B. MAXWELL, and COREY C. SNOOK for SYSTEM AND METHOD EMPLOYING PORTABLE CARDS TO MONITOR A COMMERCIAL SYSTEM, filed Apr. 29, 1999, the contents of which is herein incorporated by reference.

A scheme of programming shelf units and checkout stations is a subject of copending application Ser. No. 09/301,747 of KEN R. POWELL, ELEANOR B. MAXWELL, and COREY C. SNOOK for SYSTEM AND METHOD EMPLOYING A PORTABLE CARD TO CONFIGURE A STORE FOR PRODUCT PROMOTION, filed concurrently with the instant application, the contents of which is herein incorporated by reference.

Second Preferred Embodiment

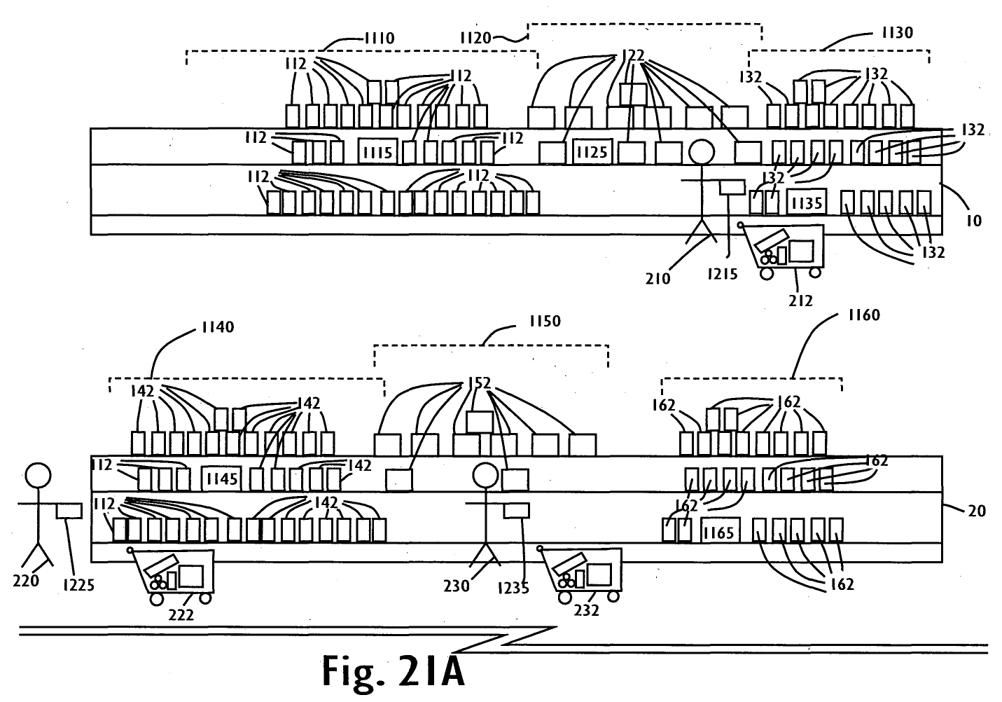

FIGS. 21A and 21B show a grocery store 1000 in accordance with a second preferred embodiment of the present invention. FIG. 21A and FIG. 21B are each a partial view of store 1000. Customers 210, 220, 230, 240, 250, 270, 280, and 290, shop in the store. Before shopping in the store, each of these customers obtained a customer card. For example, customer 230 obtained customer card 1235 from a bank, by completing an application for the bank. The application contained questions to collect demographic data, including birth date, income level, past buying patterns, geographic location, size of family, level of education, and job-related data. The bank subsequently wrote customer identification data for customer 230 onto customer card 1235, and issued customer card 1235 to customer 230, and sent the customer's demographic data to a clearinghouse which then stored the demographic data on disk. Each of customers 210, 220, 240, 250, 270, 280, and 290 obtains a respective customer card in a similar manner. In other words, for each customer the second preferred method writes demographic data for the customer onto a disk in the clearinghouse, and writes personal identification data for the customer onto a respective card for the customer.

After redemption data, including customer identification data from a plurality of cards, is compiled and sent to a clearinghouse, as described below, the customer identification data is used to access the corresponding demographic data, thereby providing the manufacturer with valuable marketing data on coupon program effectiveness and customer demographics.

Alternatively, a customer may have obtained a customer card from a store, such as store 1000, by completing a check cashing application having questions to collect demographic data.

Store 1000 includes shelves 10, 20, and 30, defining aisles between the shelves. The supermarket has a plurality of product areas, each corresponding to a respective product. Product Area 1110 has Delta brand Clothes Detergent. Product Area 1120 has Delta brand Dish Detergent. Product Area 1130 has Lighthouse brand Light Bulbs.

Some of the product areas have a respective station for reading a customer card, described in more detail below. Product Area 1110 has Station 1115. Product Area 1120 has Station 1125. Product Area 1130 has Station 1135.

More specifically, Product Area 1110 has bottles of Clothes Detergent 112 grouped together on multiple shelves. Bottles of Clothes Detergent 112 are contiguously grouped, meaning that no other product is between any two bottles of Clothes Detergent 112. No other product is between product station 1115 and bottles of Clothes Detergent 112. Product Station 1115 is on a shelf under some of the bottles 112 and over some of the bottles 112. In other words, Station 1115 is adjacent to bottles 112 and supported by a shelf that is in vertical alignment with some of the bottles 112.

Product Area 1120 has boxes of detergent 122 grouped together on multiple shelves. Boxes of detergent 122 are contiguously grouped, meaning that no other product is between any two boxes of detergent 122. No other product is between product station 1125 and boxes of detergent 122. Product Station 1125 is on a shelf under some of the boxes 122. In other words, station 1125 is adjacent to boxes 122 and supported by a shelf in vertical alignment with some of the boxes 122.

Product Area 1130 has boxes of light bulbs 132 grouped together on multiple shelves. Boxes of light bulbs 132 are contiguously grouped, meaning that no other product is between two boxes of light bulbs 132. No other product is between product station 1135 and boxes of light bulbs 132. Product Station 1135 is on a shelf under some of the boxes 132. In other words, station 1135 is adjacent to boxes 132 and supported by a shelf in vertical alignment with some of the boxes 132.

Similarly, other product area in the store each have a set of respective products contiguously grouped together and a corresponding product station adjacent to the products. The respective units of a certain product have a common label, different than labels on units of other products, that uniquely identifies the certain product. No other product is between a product station and the units of the corresponding product. Product area 1140 has bottles of ketchup 142 contiguously grouped together, and product station 1145 adjacent to the bottles of ketchup 142. Product area 1160 has bottles of Beta brand detergent 162 contiguously grouped together, and product station 1165 adjacent to bottles 162. Product area 1170 has cartons of milk 172 contiguously grouped together, and product station 1175 adjacent to cartons of milk 172. Product area 1180 has packages of bacon 182, and product station 1185 adjacent to packages of bacon 182. Product area of 1190 has packages of butter 192 contiguously grouped together and product station 1195 adjacent to packages of butter 192.

Product area 1150 has boxes of cereal 152 contiguously grouped together. Product area 1150 does not have a product station.

While shopping in store 1000, each of customers 210, 220, 230, 240, 250, 270, 280, and 290 carries his or her respective customer card. Customer 210 carries card 1215, customer 220 carries card 1225, customer 230 carries card 1235, customer 240 carries card 1245, customer 250 carries card 1255, customer 270 carries card 1275, customer 280 carries card 1285, and customer 290 carries card 1295. Each customer tows a shopping cart to hold selected products. Customer 210 tows cart 212, customer 220 tows cart 222, customer 230 tow cart 232, customer 240 tows cart 242, customer 250 tows cart 252, customer 270 tows cart 272, customer 280 tows cart 282, and customer 290 tows care 292. To create an electronic coupon, the customer inserts the card into the product station adjacent to a product the customer wishes to purchase, and the product station then writes an electronic coupon onto the card. In other words, the product station writes an electronic coupon into a memory on the card, in response to a person presenting the card at the product station. The customer then removes the product from the shelf and places the removed product into her cart. The customer thus shops throughout the store collecting electronic coupons for products of interest.

The second preferred method thus includes a step, performed for a plurality of the customer cards, of writing a product identification signal, corresponding to a selected product, onto the customer card.

Upon completion of shopping, the customer brings selected products from shelves 10, 20, and 30 to checkout counter 700. The customer redeems the electronic coupons at the checkout area, by inserting her customer card into checkout station 715. For example, a customer such as customer 290 in FIG. 21B completes the purchase of her selected products 293 by transferring products 293 from her cart 292 to counter 700, and by inserting card 295 into checkout station 715. Subsequently, a checkout clerk (not shown) scans each selected product past UPC bar code reader 710. Bar code reader 710 is an optical detector. In other words, bar code reader 710 detects an electromagnetic signal. A processor coupled to station 715 and reader 710 determines whether the most recently scanned product is on a discount list stored in card 295. If the most recently scanned product is identified in this discount list, a price for the product is determined using the discount data corresponding to the product, and the resulting price is displayed on display 717. Checkout counter 700 scans and processes each product 293 in a similar manner.

Similarly customer 280 in FIG. 21B will complete the purchase of her selected products 283 by transferring products 283 from her cart 282 to counter 700, and by inserting card 285 into checkout station 715; and the checkout clerk (not shown) will scan each selected product 283 past UPC bar code reader 710. Customer 270 will complete the purchase of her selected products 273 by transferring products 273 from her cart 272 to counter 700, and by inserting card 275 into checkout station 715; and the checkout clerk (not shown) will scan each selected product 273 past UPC bar code reader 710.

Periodically, checkout counter 700 sends redemption data to an electronic clearing house. This redemption data includes the identification of the store and of the customers who presented electronic coupons for redemption.

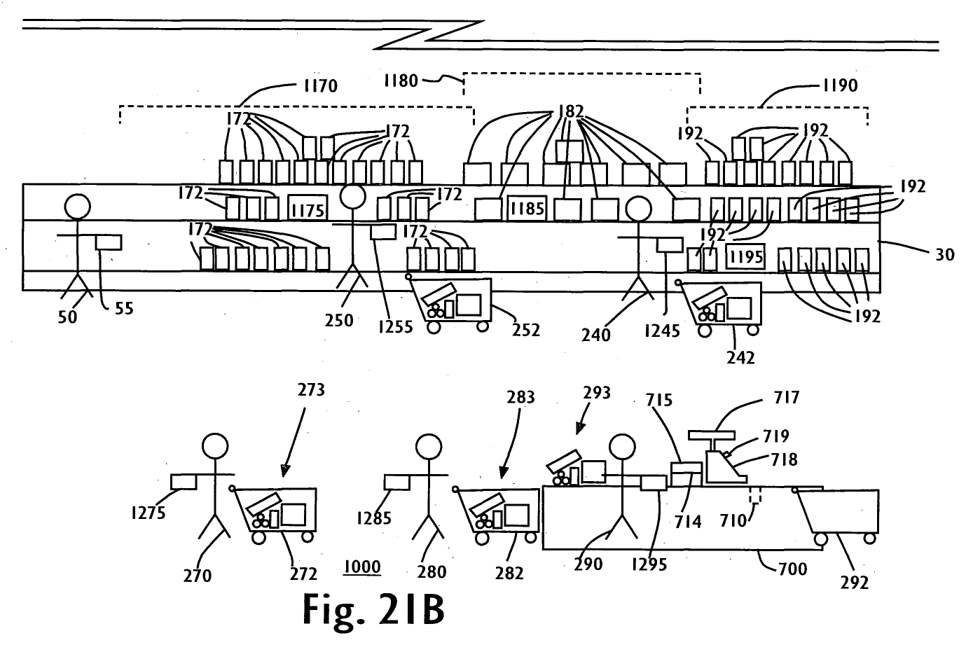

FIG. 22A shows a plan view of customer card 1215 carried by customers 210, and FIG. 22B shows a side view of card 1215. Card 215 includes a magnetic stripe 2410, interface contacts 2420 for communication with the product stations and the checkout station, and embossed area 2430 for displaying the card owner's name. Magnetic stripe 2410 allows a conventional credit card stripe reader to read basic data from the card. Magnetic stripe 2410 is not necessary to the operation of the preferred embodiments of the invention.

FIG. 22C shows interface contacts 2420 in more detail. Interface contacts 2420 are configured in accordance with ISO7816-2: 1988(E), Identification cards—Integrated circuit(s) cards with contact—Part 2: Dimensions and locations of the contacts, promulgated by the International Organization for Standardization (ISO), and available from the American National Standards Institute (ANSI), 11 West 42nd Street, New York, N.Y. 10036. According to ISO 7816-2, contact 2421 is assigned to VCC (supply voltage), contact 2422 is assigned to RST (reset signal), contact 2423 is assigned to CLK (clock signal), contact 2424 is reserved for future use, contact 2425 is assigned to GND (ground), contact 2426 is assigned to VPP (program and voltage), contact 2427 is assigned to I/O (data input/output), and contact 2428 is reserved for future use. Card 1215 communicates with the product stations and the checkout stations through contact 2427 using a half duplex scheme, meaning that contact 2427 is for communicating data signals either to or from the card.

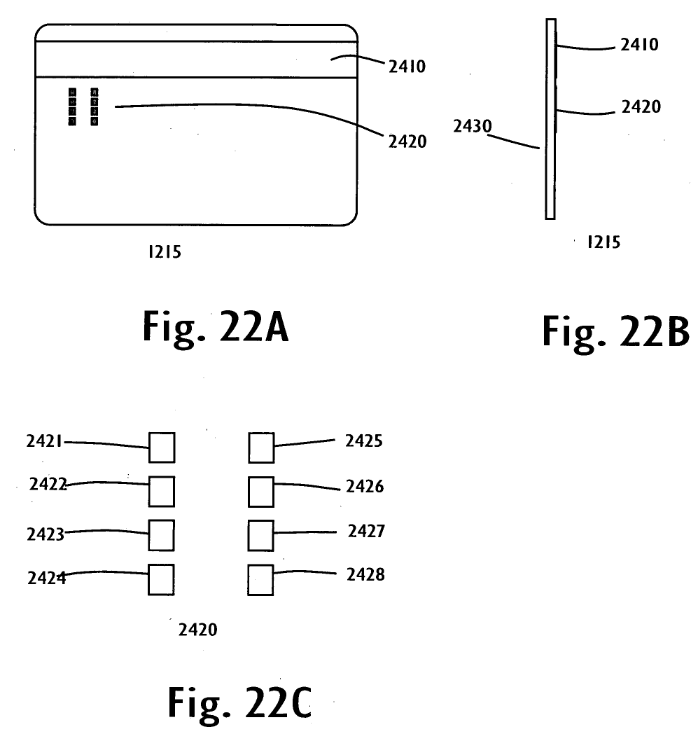

FIG. 23 is a block diagram of customer card 1215, including central processing unit 2450, memory 2460, and battery 2470 for supplying power to interface 2425, processor 2450, and memory 2460. Memory 2460 is a random access, addressable device. Station interface 2425 includes a serial to parallel converter for transferring data signals between contact 2427 and CPU 2450 over parallel bus 2452. Memory 2460 stores a program 2465 executed by processor 2450, customer identification data 2467, and authorization data 2468. Customer identification data 2467 includes a sequence of digits that uniquely identifies the holder of the card. Customer identification data 2467 includes the card holder's social security number. For example, identification data 2467 in customer card 1235 uniquely identifies customer 230. Authorization data 2468 includes a sequence of digits that includes a code identifying the store or stores in which the card may be used to obtain a paperless coupon. Authorization data 2468 also includes date data indicating an expiration date for the card. Depending on the card holder's contractual relationship with the card issuer, the card issuer may periodically update this date data to renew the card when the current date data indicates the card is expired. Store authorization data 2468 also contains a field identifying that the card is a customer card (rather than a programming card, which is described below).

Memory 2460 also stores product data received from one or more of the product stations. This product data includes a list of product discounts 2435. When a customer inserts a customer card into one of the product stations, processor 2450 receives an identification code for the product from the station and adds the code to the list.

Each of customer cards 1225, 1235, 1245, 1355, 1275, and 1295 has the same hardware structure as customer card 1215.

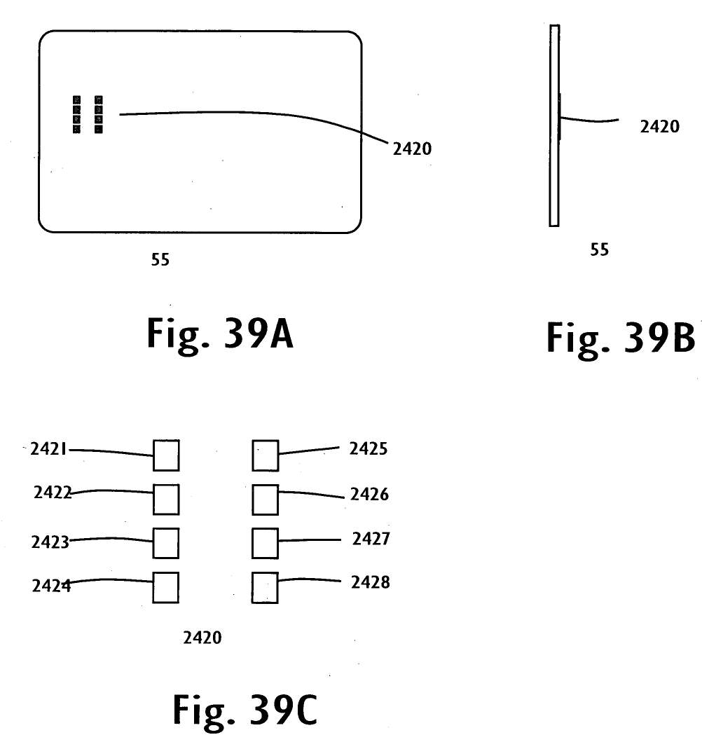

Programming card 55 has the same hardware structure as customer card 1215. FIG. 39A shows a plan view of programming card 55, and FIG. 39B shows a side view of card 55. Card 55 is 8.5 cm by 5.4 cm, the length and width of a typical financial credit card. Card 55 is slightly thicker than a typical financial credit card. Card 55 includes interface contacts 2420 for communication with the product stations and the checkout station, and embossed area 2430 for displaying information about the card.

FIG. 39C shows interface contacts 2420 in more detail. Interface contacts 2420 are configured in accordance with ISO7816-2: 1988(E), Identification cards—Integrated circuit (s) cards with contact—Part 2: Dimensions and locations of the contacts, promulgated by the International Organization for Standardization (ISO), and available from the American National Standards Institute (ANSI), 11 West 42nd Street, New York, N.Y. 10036. According to ISO 7816-2, contact 2421 is assigned to VCC (supply voltage), contact 2422 is assigned to RST (reset signal), contact 2423 is assigned to CLK (clock signal), contact 2424 is reserved for future use, contact 2425 is assigned to GND (ground), contact 2426 is assigned to VPP (program and voltage), contact 2427 is assigned to I/O (data input/output), and contact 2428 is reserved for future use. Card 55 communicates with the product stations through contact 2427 using a half duplex scheme, meaning that contact 2427 is for communicating data signals either to or from the card.

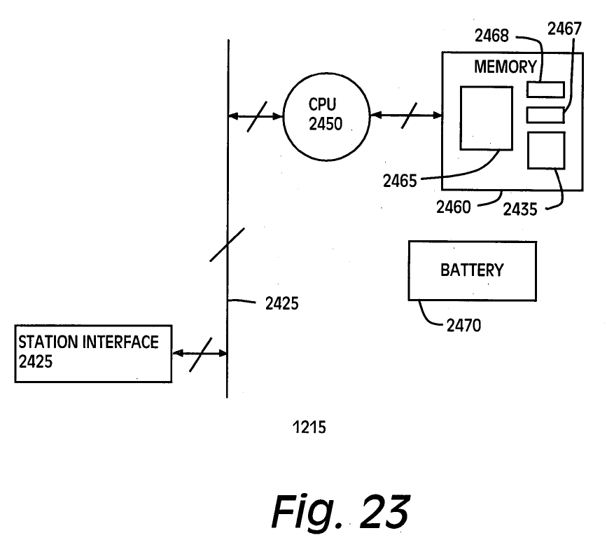

FIG. 24 shows product station 1115, including green light 4155, red light 4160, and interface slot 4170. Station 1115 also has an optional liquid crystal display (LCD) for displaying product promotional messages. Interface slot 4170 has a width sufficient to accommodate the width of one of the customer cards. When a customer card is in interface slot 4170, conductive contact 4177 inside interface slot 4170 touches contact 2427 on the customer card. Interface slot 4170 has other contacts (not shown) for touching the other card contacts 2420.

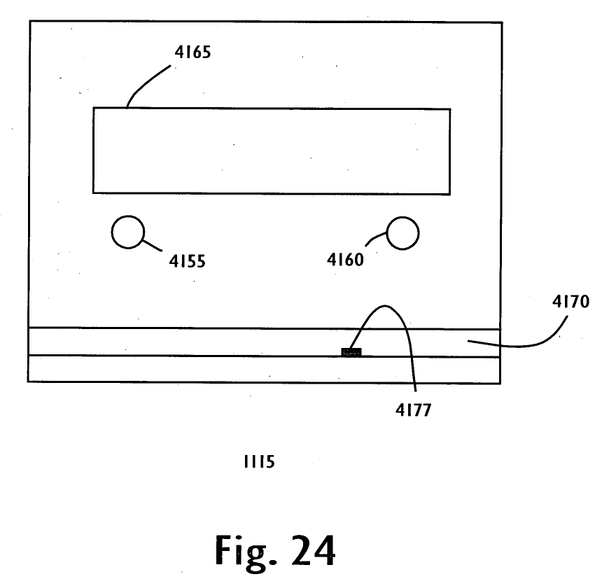

FIG. 25 shows a block diagram of station 1115, including central processing unit 5160, memory 5165, and battery 5170. Memory 5165 stores program 5145, executed by CPU 5160, and product data 5135. Memory 5165 is a random access, addressable device.

Station 1115 has no external wires connecting station 1115 to another device. There is no need for external wires because station 1115 is powered by its own battery 5170, and is programmed by programming card 55 described in more detail below.

Each product station of the second preferred embodiment has the same hardware structure as product station 1115. Each product station is locked to one of the shelves with a keyed lock.

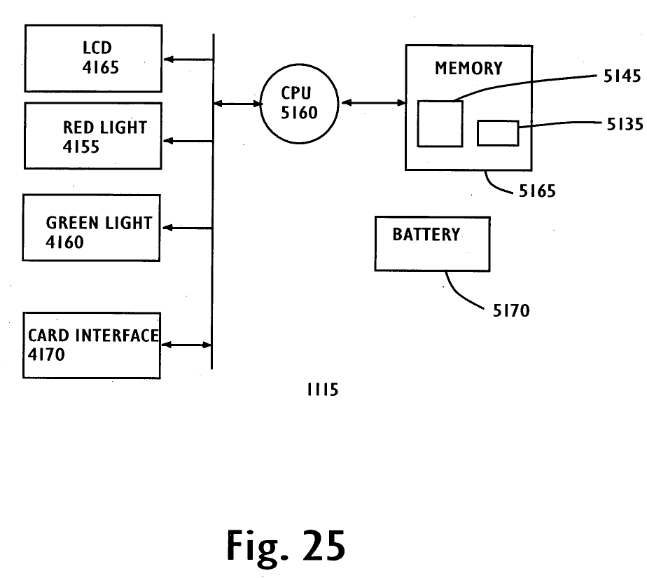

FIG. 26 is a block diagram of checkout counter 700 shown in FIG. 21B. Disk 725 provides long term storage. CPU 750 executes instructions in random access, addressable memory 720. Transformer 705 transforms 60 Hz line power into DC power and provides the DC power to CPU 750 memory 720, UPC reader 710, checkout station 715, and other electronics within checkout counter 700.

CPU 750 and program 722 act to detect a product scanned by UPC reader 710, determine a reference price for the product, search for the product's identification in the memory of a customer card, and deduct a discount from the reference price if the product is identified in the customer card memory. CPU 750 then displays the price of the product on display 717. CPU 750 writes coupon redemption data onto disk 725. Periodically, CPU 750 sends the redemption data to an electronic clearing house through modem 730.

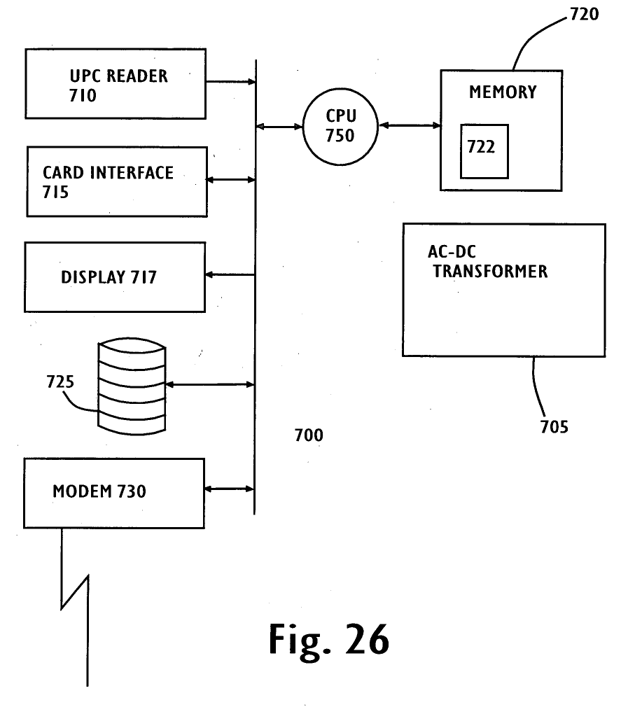

FIG. 27 shows a processing performed by processor 5160 and program 5145 in product station 1115. CPU 5160 and a program in memory 5165 act to perform the processing shown in FIG. 27. When a person inserts a card into interface slot 4170 a switch (not shown) in interface slot 4170 alerts CPU 5160 that a card has been inserted into the slot. Subsequently, CPU 5160 causes card interface 4170 to reset the card by applying a clock signal to contact 2423. (If the card is a customer card, the card then answers the reset by sending a block of data, including identification data 2467 and authorization data 2468, through card contact 2427. Authorization data 2468 contains a card-type code indicating a customer card. If the card is a programming card, the card send then answers the reset by sending a data block, including authorization data 2458, through card contact 2427. Authorization data 2458 has a card-type code indicating a programming card.) CPU 5160 then receives then receives the answer-to-reset data block from the card (step 10).

The communication protocol between product station 11.15 and a customer card is described in more detail in ISO/IEC 7816-3: 1989 (E), Identification cards—Integrated circuit(s) cards with contacts—Part 3: Electronic signals and transmission protocols; and ISO/IEC 7816-3: 1989/Amd. 1: 1992 (E), Part 3: Electronic signals and transmission protocols, AMENDMENT 1: Protocol type T=1, asynchronous half duplex block transmission protocol. Both of these standards are promulgated by the International Organization for Standardization (ISO) and distributed by the American National Standards Institute (ANSI).

CPU 5160 analyzes the authorization data in the received answer-to-reset block to determine whether the card is a customer card that is eligible to receive paperless coupons in store 1000 (step 20). CPU 5160 determines that the card is a customer card if the received authorization data contains a card-type code indicating a customer card. If the card is a customer card, meaning that the authorization data is authorization data 2468, CPU 5160 determines if the card is eligible to receive paperless coupons in store 1000 if authorization data 2468 contains a store code indicating store 1000, and the current time and date (as indicated by a date-time clock inside processor 4160) is not later than the date data in authorization data 2468. If the card is an eligible customer card, CPU 5160 sends to the customer card a block containing a station-type code indicating a product station, and product coupon data 5135 from locations 250-275 (step 40). Product coupon data 5135 includes an identification code for the product currently being promoted by the product station (bottles of Clothes Detergent 112) and the discount currently being offered for that product. CPU 5160 then turns on green light 4160 to indicate to the customer that an electronic coupon has successfully been transferred to her customer card (step 60), thereby allowing the customer to conveniently verify whether she is eligible for a discount before selecting the product.

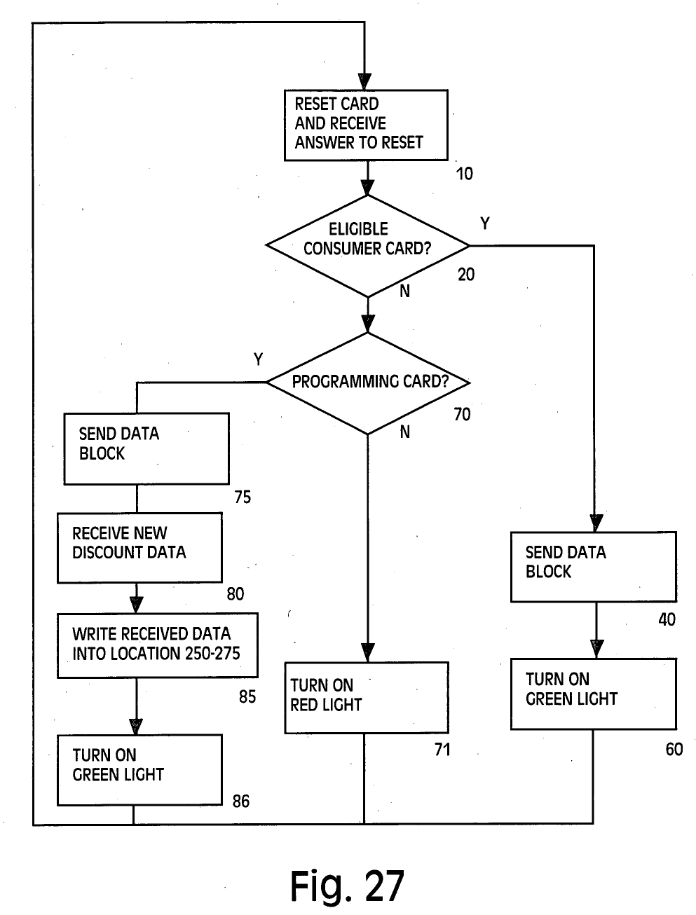

FIG. 28A shows some the contents list 2435 in starting at location 30 memory 2460 of customer card 1215, before CPU 5160 of the product station executes step 40. An electronic coupon is represented by three rows in list 2435: a 12 digit UPC product code in the first row, discount format data in the second row (“1” signifying cents, “2” signifying percentage), and discount quantity data in the third row. In FIG. 28A, the customer card is storing two electronic coupons in a list starting at location 30 in memory 2460, reflecting the fact that customer 210 has received electronic coupons from two product stations during her current visit to store 1000. After CPU 5160 executes step 40 (thereby sending an electronic coupon to the customer card), CPU 2450 in customer card 1215 receives the data and adds the data to list 2435, resulting in three electronic coupons in list 2435 as shown in FIG. 28B.

CPU 5160 determines that the card is a programming card if the card-type code in the received authorization data indicates a programming card. If the card is not a an eligible customer card but is instead a programming card meaning that the authorization data is authorization data 2458 (step 70), CPU 5160 sends to a block containing a station-type code indicating a product station (step 75), and CPU 5160 receives additional data from the card (step 80) and changes product data 5135 by writing the additional data to locations 250-275 (step 85), thereby changing the electronic coupon dispensed by the product station.

If the card is an ineligible customer card, CPU 5160 turns on red light 4155 to notify the consumer that she did not receive a discount for the product.

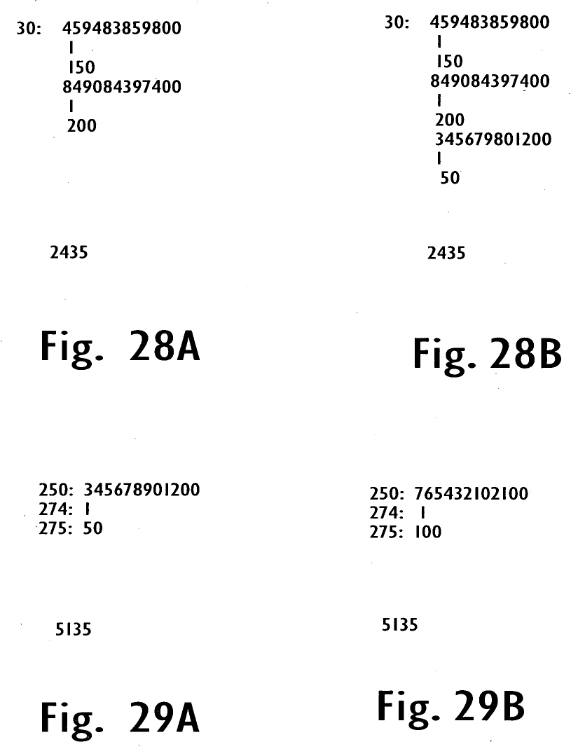

FIG. 29A shows product data 5135 before the execution of step 85, and FIG. 29B shows product data 5135 after step 85. The data starting at location 250 stores identification for a product. In this example product code “345678901200” corresponds to the UPC code on Clothes Detergent bottles 112. Location 274 stores the format of the discount quantity data, with “1” signifying cents and “2” signifying percentage in tenths of a percent. Location 275 stores the discount quality data. In FIG. 29A, because location 275 is storing a 50, the discount being offered for Clothes Detergent bottles 112 is 50 cents. In FIG. 20B, the discount being offered for another product is 100 cents.

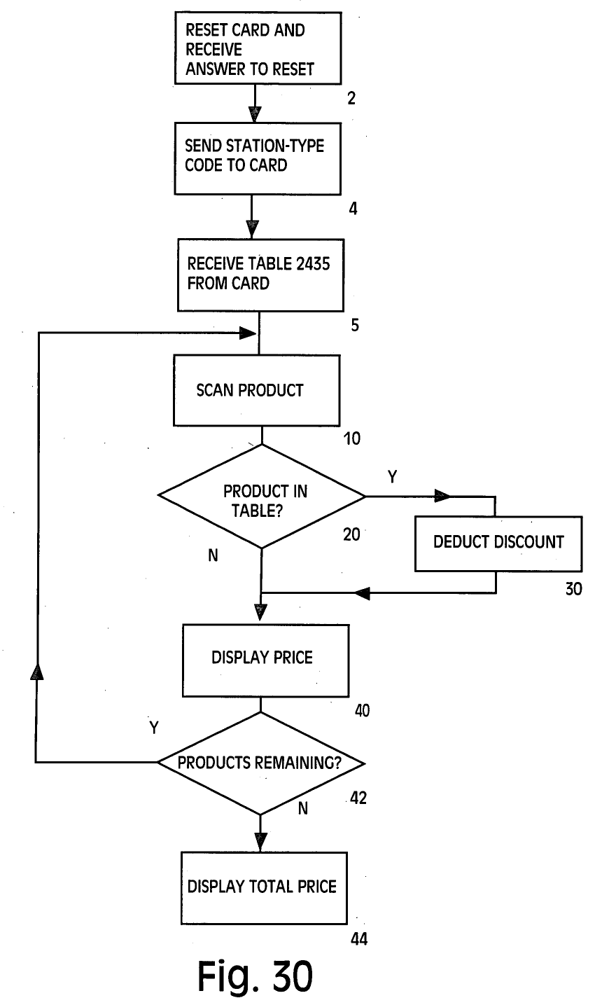

FIG. 30 shows a processing performed by CPU 750 and program 722 in checkout counter 700, when a customer checks out of store 1000. When a customer, such as customer 290, inserts customer card 1295 into interface slot 714, a switch (not shown) in interface slot 714 alerts CPU 750 that a card has been inserted into the slot. When a customer card is in interface slot 714, conductive contacts (not shown) inside interface slot 714 touch each card contact 2420. Subsequently, CPU 750 causes card interface 725 to reset the card by applying a clock signal to card contact 2423. (If the card is a customer card, the card then answers the reset by sending a block of data, including identification data 2467 and authorization data 2468, through card contact 2427.) CPU 750 then receives the answer-to-reset from the card (step 2). CPU 750 then sends a data block containing a station-type code indicating a checkout station (step 4). CPU 750 then receives the contents of table 2435 in memory 2460 of the customer card, and temporarily stores these table contents in memory 720 of the checkout station (step 5). During step 5, CPU 750 also causes customer card 1295 to remove all entries from list 2435, so that the electronic coupons in the list cannot be redeemed again. When the checkout clerk (not shown) moves a product past UPC reader 710, UPC reader 710 detects the UPC code on the product and sends the UPC code to CPU 750 (step 10). CPU 750 searches the received table contents to determine whether the product scanned is identified in the table (step 20). If the product is in the received table, CPU 750 subtracts the discount, as determined by the discount data stored in the received table, from a product reference price read from disk 725 (step 30), and displays the resulting price of the product on display 717 (step 40).

Product data 5135, customer identification data 2467, authorization data 2468, and the data in list 2435 are each a type of signal.

In other words, the second preferred retail system 1000 includes product areas 1110, 1120, 1130, 1140, 1160, 1170, 1180, and 1190; product stations 1115, 1125, 1135, 1145, 1165, 1175, 1185, and 1195 acting as a plurality of first communication ports each adjacent to a respective one of the product areas, a plurality of customer cards each having a memory, and a checkout counter 700 having checkout station 715 acting as a second communication port. A method of operating system 1000 comprises the steps of writing a first signal into memory 2460 of a card in the plurality of cards, in response to a person inserting the card into the interface slot of one of the product stations, the first signal identifying a product in the product area adjacent to the one of the first communication ports; reading the first signal from memory 2460, in response to a person inserting the card into the interface slot of the checkout station; receiving a second signal, from UPC reader 710, identifying a product; and determining a price for the product depending on whether the product identified by the first signal, read in the reading step, corresponds to the product identified by the second signal.

In summary, after UPC barcode reader 710 scans a product, processor 750 determines eligibility for a discount. If a product qualifies, processor 750 displays the discounted price on display 717. Periodically, electronic coupon data is processed and reported to a clearing house.

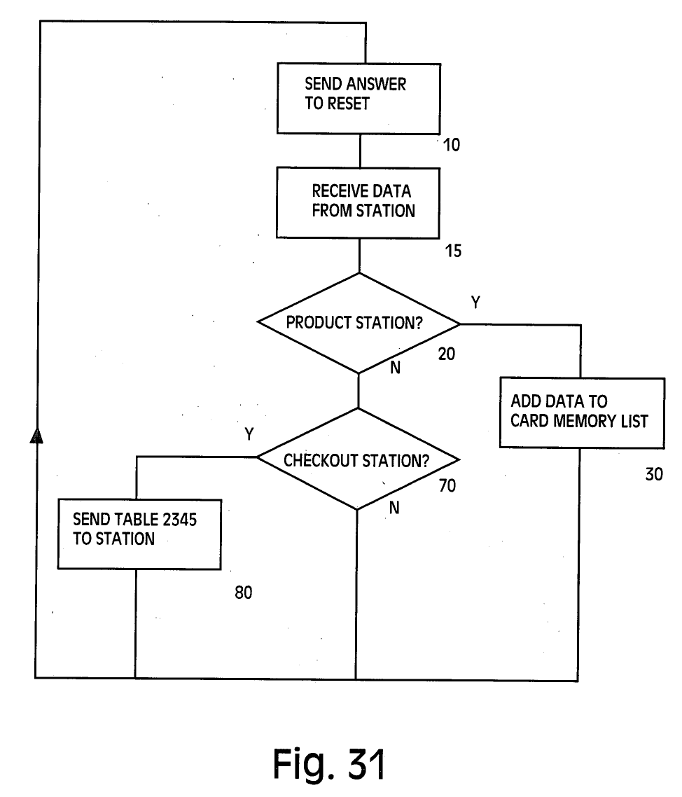

FIG. 31 shows a processing performed by one of the customer cards, such as customer card 1215, in the second preferred retail system. After the card is reset through contacts 2420, the customer card sends an “answer to reset” data block in accordance with the ISO standard ISO/IEC 7816-3: 1989(E), cited above. The customer card sends identification data 2467 and authorization data 2468 in the answer-to-reset data block (step 10). If the station then sends a block of data to the customer card, the customer card then receives the block of data through contact 2427 (step 15). If the block contains a station-type code indicating a product station (step 20), the customer card then adds product coupon information, from a certain location in the block, to the list 2345 (step 30).

If the customer card is not eligible, the station will not send a block of data, step 15 therefore does not execute, and processing ceases until the customer card is reinserted into a station, at which time the station will reset the card and processing will restart at step 10.

Alternatively, if the block contains a station-type code indicating a checkout station (step 70), the customer card then sends list 2345 to the checkout station (step 80). In other words, CPU 2450 reads list 2435 from memory 2460, in response to a customer inserting card 1215 into checkout station 715, and sends a signal corresponding to the list 2345 to the checkout station (step 80).

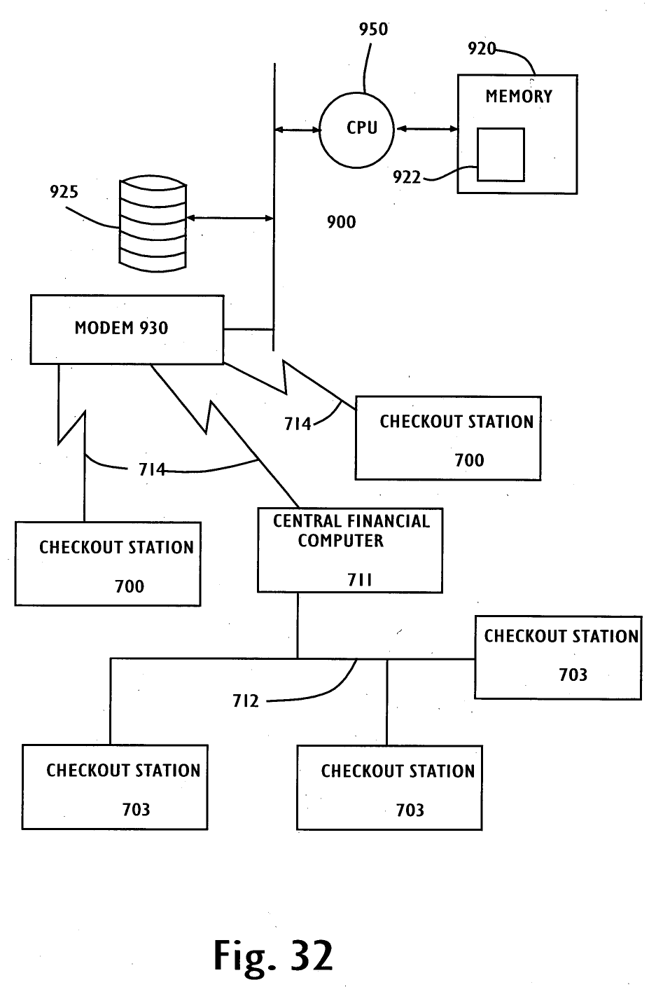

FIG. 32 shows a block diagram of a second preferred retail system including a clearinghouse 900, and a plurality of checkout stations 700. Periodically, each checkout station 700 sends a block of data summarizing the redemption transactions. The checkout stations send the data blocks, over telephone lines 714, to clearinghouse 900. The block includes the data shown in Table 1, below.

TABLE 1

| [customer ID 1] | [UPC code 1] |
|---|---|
| [customer ID 2] | [UPC code 2] |
| [customer ID 3] | [UPC code 3] |
| [customer ID 4] | [UPC code 4] |
| . | |
| . | |
| . | |
| [customer ID n] | [UPC code n] |

Each row in table 1 records a redemption transaction. Each customer ID number is a copy of data 2467 from a customer card. Each UPC code is a copy of product data 5135 from one of the product stations.

Clearinghouse memory 925 stores demographic data records. Each record is indexed by customer ID. As shown in Table 2, below, each row represents a demographic record for a customer. The first entity in each row is the record key, or index. The second entity is date of birth, and the third entity is yearly income.

TABLE 2

| | | |
|---|---|---|
| [customer ID 1] | Mar. 12, 1944 | 30,100 |
| [customer ID 1] | Mar. 12, 1964 | 23,700 |
| [customer ID 1] | Mar. 12, 1932 | 30,100 |
| [customer ID 1] | Mar. 12, 1905 | 89,000 |
| | . | |
| | . | |
| | . | |
| [customer ID n] | Dec. 12, 1975 | 19,100 |

Processor 950 processes transaction data blocks, such as the block shown in Table 1, and uses the customer Ids in the data blocks to access demographic records, such as the record shown in Table 2. Processor 950 then generates a report summarizing certain trends, such as the report shown in Table 3, below.

TABLE 3
DELTA CLOTHES DETERGENT COUPON REDEMPTIONS
FOR MARCH 1995

| | |
|---|---|
| AGE RANGE | TOTAL BOTTLES SOLD WITH COUPON |

| | | |
|---|---|---|
| 15-25 | 60,456 | (30%) |
| 25-40 | 102,345 | (51%) |
| 40-60 | 14,345 | (7%) |
| over 60 | 23,456 | (12%) |
| all ages | 200,602 | (100%) |

Checkout stations 703 are located within a single company. Checkout stations 703 are similar to checkout stations 700, described above, except that checkout stations 703 have circuitry for communicating over network 712. Checkout stations 703 send transaction data blocks to central financial computer 711 located within the company. Central financial computer 711 periodically sends the compiled transaction data to clearing house 900, over telephone lines 714.

In other words, the system shown in FIG. 32, and the corresponding product stations, perform a method of determining retail buying patterns. The method writes demographic data, obtained from a customer application questionnaires described above, into memory 925. The method writes personal identification data 2467 onto customer cards. Subsequently, one or more product stations writes a product identification data, corresponding to a selected product, onto certain ones of the cards. Subsequently, a checkout station reads the personal identification data 2467 from certain ones of the cards to generate a first read signals, and reads the product identification data from certain ones of the cards to generate second read signals. These first and second signals are sent to clearinghouse 900, which generates a report using the first and second signals. Clearinghouse 900 generates the report by accessing the demographic data, using the first signal, to generate a demographic signal; and by correlating the demographic signal (indicating age) with the second signal (purchases of Clothes Detergent).

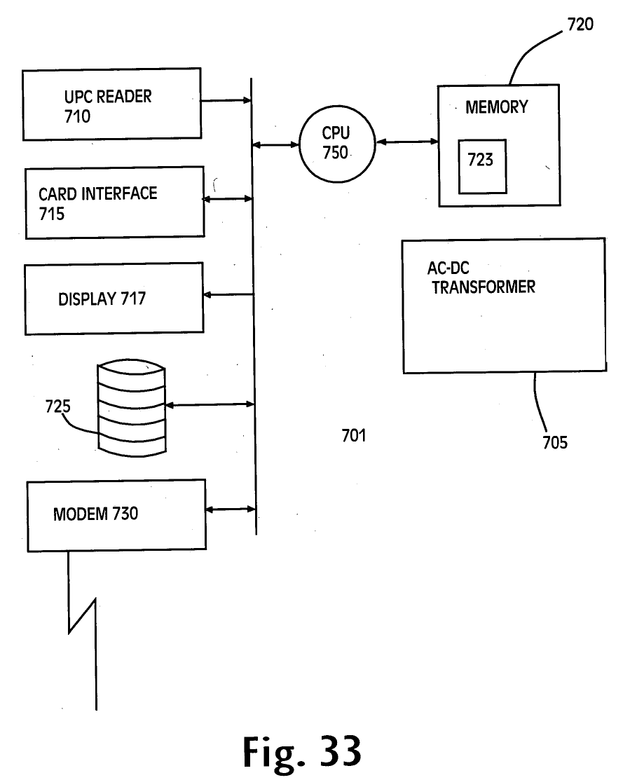

FIG. 33 is a block diagram of checkout counter 701 in accordance with an alternative embodiment of the present invention. Checkout counter 701 is similar to checkout counter 700 shown in FIG. 26, except that checkout counter 701 has program 723.

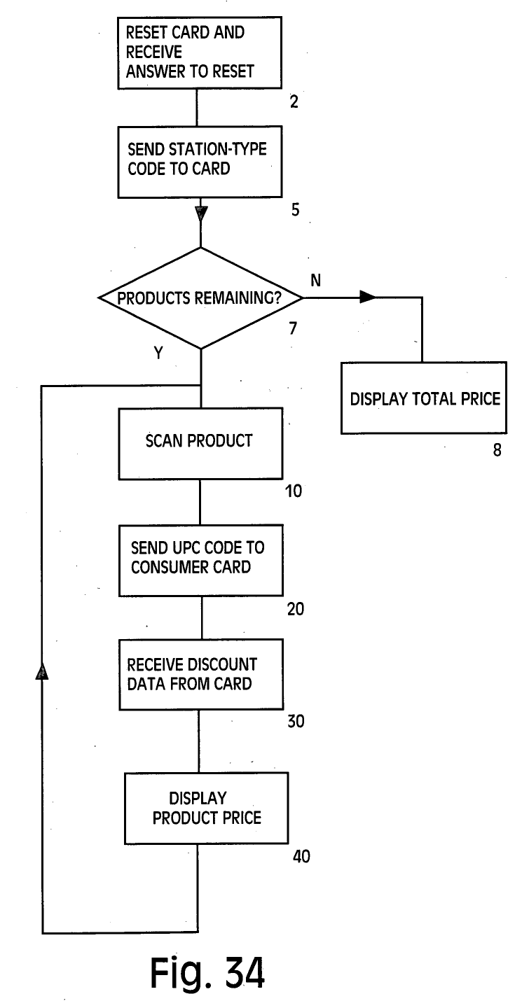

FIG. 34 shows a flow chart of a processing performed by CPU 750 and program 723 in checkout counter 701. When a customer, such as customer 290, inserts customer card 1295 into interface 715, CPU 750 causes card interface 750 to reset the card (step 2). CPU 750 then sends a block of data containing a station-type code indicating a checkout station (step 5). If there are no product remaining to be scanned (step 7), the checkout clerk (not shown) presses the “total” button 719 on cash register 718, causing CPU 750 to display the total price (accumulated from step 40) on display 717, and to send the card a data block containing zero in the first word (step 8). If there are products remaining (step 7), the clerk moves a product past UPC reader 710, UPC reader 710 detects the UPC code on the product and sends the UPC code to CPU 750 (step 10). CPU 750 then sends a data block to the card, with the UPC code stored at the first word of the data block (step 20). In other words, CPU 750 sends a UPC signal, identifying a product, to the card. CPU 750 then receives a data block containing discount data from the card (step 30) and displays the resulting price of the product on display 717 (step 40). The received discount data will either be 0, signifying that there is no coupon corresponding to the UPC code sent to the card, or will be non-zero data consisting of the discount format and quantity data, described above in connection with FIGS. 28A and 28B, corresponding to the UPC code.

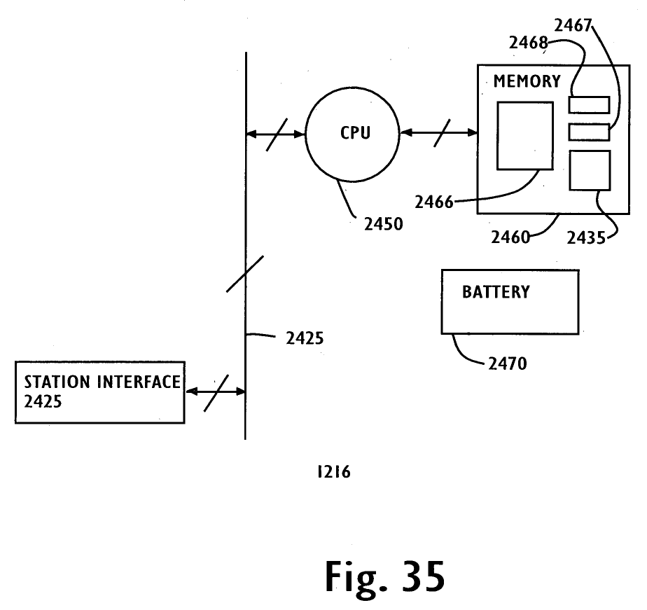

FIG. 35 shows customer card 1216 in accordance with the alternative embodiment of the present invention. Customer card 1216 is similar to customer card 1215 described above, except that customer card 1216 has program 2466 in memory 2460.

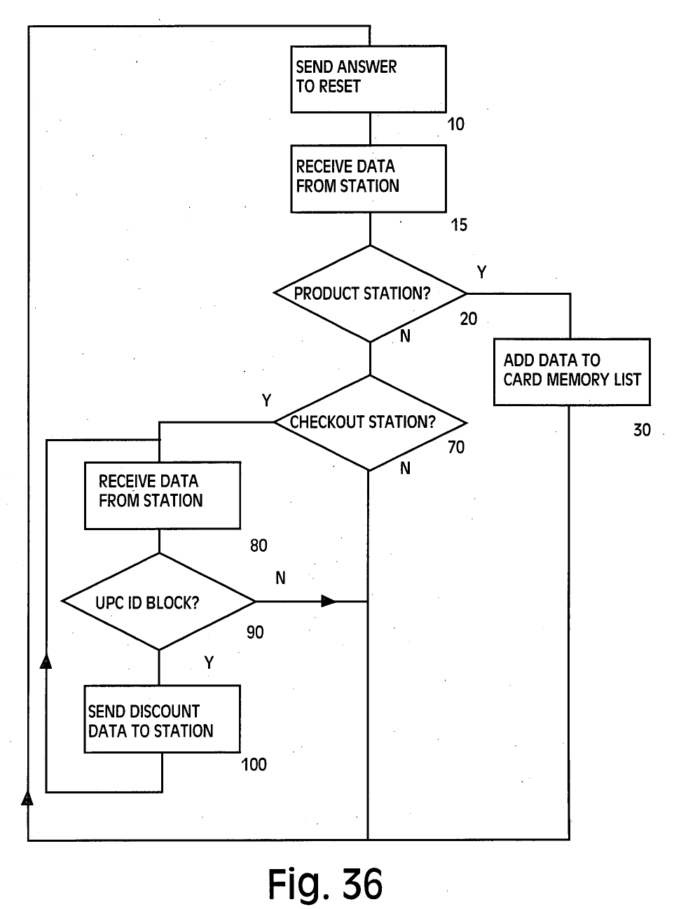

FIG. 36 shows a processing performed by CPU 2450 and program 2466. After the card is reset through contacts 2420, the customer card sends an “answer to reset” data block in accordance with the ISO standard ISO/IEC 7816-3: 1989(E), cited above. The customer card also sends data identifying the card (step 10). The customer card then receives a block of data through contact 2427 (step 15). If the block contains a station-type code indicating a product station (step 20), the customer card then adds product coupon information, from a certain location in the block, to the list 2345 (step 30). Alternatively, if the block contains a station-type code indicating a checkout station (step 70), the customer card then receives another block from the station (step 80). If the first word in the block is non-zero, there is a UPC code stored in the block (step 90). The card searches list 2345 for this UPC code, sends the station a block containing a zero in the first word if the UPC code is not in table 2345, or sends the station a block containing the discount format and discount quantity data corresponding to the UPC code if the UPC code is in table 2345. Processing then returns to step 80.

If the first word in the block received in step 80 is zero (indicating that the last product has been scanned), the card then exits the loop of steps 80, 90, and 100, and processing returns to step 10.

An advantage of the alternative embodiment of the invention is that the software in the checkout station need only send UPC codes to the customer card and receive discount data from the customer card, allowing the invention to be practiced using relatively simple modifications to conventional checkout station software. Further, the integrity of the conventional checkout station is assured since no complicated foreign software need be intermingled with the conventional checkout station software.

A variation of the alternative embodiment is to have the customer card receive UPC codes from the checkout station as described above, but defer sending discount data to the checkout station until the last product is scanned. After the last product is scanned, the customer card would then send a list of UPC codes, with respective discount data for each UPC code, to the checkout station.

In FIG. 21B, service worker 50 carries a programming card 55 for reprogramming the product stations. The hardware architecture of service card 55 is the same as the architecture of customer card 1115, discussed above. The software in the memory of service card 55, however, is different than the software in the customer cards. Service card 55 has software to allow the product station to recognize that service card 55 is authorized to alter the memory contents of the product stations, as discussed in more detail below. Programming card 55 has a memory containing discount data for a product.

In other words, product station includes an electrical contact 4177. The writing step, described above, communicates between a customer card and a product station through electrical contact 4177. The second preferred method also includes a step of changing the selected product by sending a programming signal from the programming card 55 to the product station through electrical contact 4177.

In other words, service worker 55 creates a signal path to one of the product stations by inserting programming card 55 into the interface slot of the product station. The programming card then changes the selected product by sending a programming signal to the product station through contact 4177. Service worker 55 then breaks the signal path by removing programming card 55.

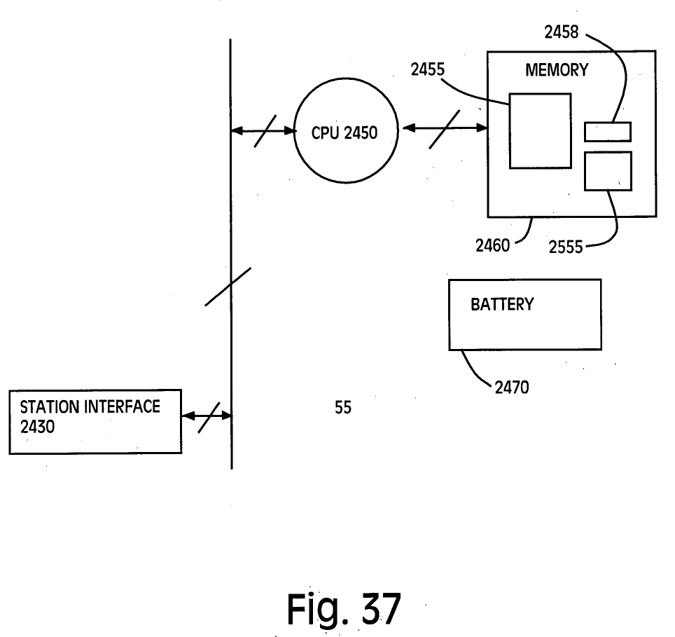

FIG. 37 shows a block diagram of a programming card 55 in accordance with the second preferred embodiment of the present invention. Programming card 55 is similar to customer card 1215, except that programming card has program 2455, authorization data 2458, and new discount data 2555 in addressable, random access memory 2460. Authorization data 2458 and new discount data 2555 are each a type of signal.

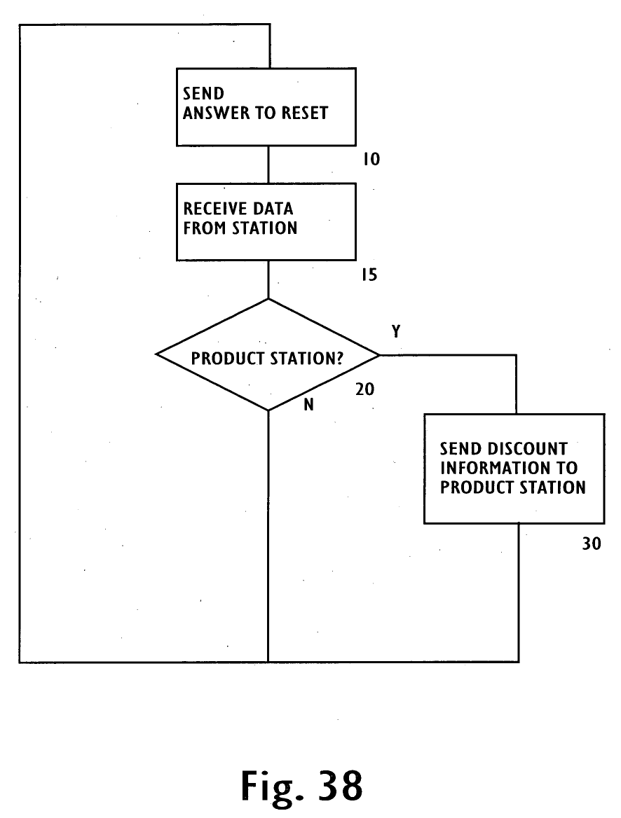

FIG. 38 shows a processing performed by CPU 2450 and program 2455 in program card 55. After programming card 55 is reset through contacts 2420, programming card 55 sends authorization data 2458 in an answer-to-reset data block in accordance with the ISO standard ISO/IEC 7816-3: 1989(E), cited above (step 10). Authorization data 2458 has a card-type code indicating that the card is a programming card. Programming card 55 then receives a block of data through contact 2427 (step 15). If the block contains a station-type code indicating a product station (step 20), the programming card 55 card then sends discount data 2555 (step 30).

Thus, the second preferred system provides a convenient and stimulating shopping environment without requiring an elaborate hardware configuration throughout the store. The product stations of the preferred system may be compact. This compactness allows the product stations to be placed adjacent to the corresponding products.

Demographic data and redemption data, compiled by the checkout station, provide manufactures with timely feedback about the effectiveness of product promotion programs. The potential for coupon fraud and misredeemption is reduced, as each coupon is ultimately traceable to an individual customer.

Although the illustrated portable customer card and portable programming card are each 8.5 cm long by 5.4 cm wide, the invention may be practices with other portable card dimensions. Preferably the portable card dimension is less than 15 cm long by 10 cm wide.

Although the second preferred system employs a programming card, having an interface compatible with the customer card interface on each product station, programming of the product station may be performed with other types of programming interfaces, disengaged from the product station except when programming is performed. For example, instead of a programming card, a service worker may carry a portable computer that temporarily connects to the product station with a cable. With this cable scheme, the service worker creates a signal path to the product station by plugging the cable into the product station. The portable computer then changes the selected product by sending a programming signal through the cable to the product station. Subsequently, the service worker breaks the signal path by disconnecting the cable from the product station.

Alternately, no programing of the production station need be performed in the store.

Conclusion

Benefits, other advantages, and solutions have been described above with regard to specific examples. The described benefits, advantages, solutions, and any element(s) that may cause any benefit, advantage, or solution to occur or become more pronounced are not critical, required, or essential feature or element of the invention.

Additional advantages and modifications will readily occur to those skilled in the art. The invention in its broader aspects is not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system including a first store with a shelf, the method comprising the step, performed in the first store, of:
detecting a first product purchased by a customer,
wherein the method further includes
displaying an amount for a second product, from the shelf, depending on the detecting step.

2. The method of claims 1 wherein the business entity that supplies the second product is different from the business entity that supplies the first product.

3. The method of claim 1 wherein the business entity that supplies the second product is the same as the business entity that supplies the first product.

4. The method of claim 1 wherein the system further includes a plurality of portable cards, and the method further includes
sending a first signal to a card in the plurality of portable cards, responsive to the detecting step.

5. The method of claim 1 wherein the system further includes a plurality of portable cards, and the method further includes
displaying the amount includes displaying responsive to a first signal on a card in the plurality of cards.

6. The method of claim 5 further including
receiving a second signal corresponding to a product selected for purchase; and
determining an amount due depending on whether the second signal corresponds to a first signal on the card.

7. The method of claim 5 further including selectively sending a second signal further depends on a value of the first signal.

8. The method of claim 5 further including
selectively sending a second signal to the card, depending on whether the first and second signals correspond to a common company.

9. The method of claim 8 wherein selectively sending a second signal further depends on a value of the first signal.

10. The method of claim 5 further including
modifying the first signal; and
sending the modified signal to the card.

11. A system for operating with a first store having a shelf, the system comprising:
a detector that detects a first product purchased by a customer, to generate a first signal; and
a display supported by the shelf, the display acting to display an amount for a second product, responsive to the first signal.

12. The system of claim 11 further including a housing; and a card reader in the housing, wherein the display is in the housing.

13. The system of claims 11 wherein the business entity that supplies the second product is different from the business entity that supplies the first product.

14. The system of claim 11 wherein the business entity that supplies the second product is the same as the business entity that supplies the first product.

15. The system of claim 11 further including a sender that transfers a first signal to a card in a plurality of portable cards, responsive to the detecting step.

16. The system of claim 11 wherein the display is responsive to a first signal on a card in the plurality of cards.

17. The system of claim 16 further including
a receiver that receives a second signal corresponding to a product selected for purchase; and
a determiner that determines an amount due depending on whether the second signal corresponds to a first signal on the card.

18. The system of claim 16 further including
logic for selectively sending a second signal to the card, depending on whether the first and second signals correspond to a common company.

19. The system of claim 18 wherein the logic includes a comparator responsive to a value of the first signal.

20. A system for operating with a first store with a shelf, the system comprising:
means for detecting a first product purchased by a customer; and
means for displaying an amount for a second product, from the shelf, depending on the detecting step.

21. The system of claims 20 wherein the business entity that supplies the second product is different from the business entity that supplies the first product.

22. The system of claim 20 wherein the business entity that supplies the second product is the same as the business entity that supplies the first product.
